(19) United States
(12) Patent Application Publication
(10) Pub. No.: US 2011/0055041 A1
(43) Pub. Date: Mar. 3, 2011

(54) SYSTEM AND METHOD FOR MANAGING WORKFORCE TRANSITIONS BETWEEN PUBLIC AND PRIVATE SECTOR EMPLOYMENT

(76) Inventors: Steven A. Shaw, Warwick, RI (US); Wyatt Wasicek, Round Rock, TX (US); Scott C. Thornburg, Yorba Linda, CA (US); Andrew A. Cullen, Succasunna, NJ (US)

(21) Appl. No.: 12/871,725

(22) Filed: Aug. 30, 2010

Related U.S. Application Data
(60) Provisional application No. 61/237,924, filed on Aug. 28, 2009.

(51) Int. Cl. G06Q 10/00; G06Q 30/00

(52) U.S. Cl. 705/26.3; 705/321

(57) ABSTRACT

A method includes configuring a labor pool, the labor pool including a plurality of human resources in a first workforce sector. In addition, the method includes configuring a plurality of business entities operating in a second workforce sector that is distinct from the first workforce sector. The configuration of a plurality of business entities includes storing job-opening information for a plurality of job openings. Further, the method includes normalizing the labor pool to a human-capital management (HCM) taxonomy. Additionally, the method includes normalizing the plurality of job openings to the HCM taxonomy. The method also includes facilitating a redeployment of at least one human resource in the normalized labor pool from the first workforce sector to the second workforce sector. The facilitating includes matching the at least one human resource to at least one job opening in the normalized plurality of job openings.

### CROSS-REFERENCE TO RELATED APPLICATIONS

This application claims priority from, and incorporates by reference the entire disclosure of, U.S. Provisional Application No. 61/237,924 filed on Aug. 28, 2009. This application incorporates by reference the entire disclosure of U.S. patent application Ser. No. 10/412,096, filed on Apr. 10, 2003, U.S. patent application Ser. No. 12/342,116, filed on Dec. 23, 2008, U.S. patent application Ser. No. 12/492,438, filed on Jun. 26, 2009, U.S. patent application Ser. No. 12/692,937, filed on Jan. 25, 2010, U.S. patent application Ser. No. 11/351,835, filed on Feb. 10, 2006, and U.S. patent application Ser. No. 11/698,603, filed on Jan. 25, 2007.

### BACKGROUND

1. Technical Field

This invention relates generally to electronic classification of data and more particularly, but not by way of limitation, to a system and method for facilitating redeployment of human resources from one workforce sector to another.

2. History of Related Art

For a variety of reasons, human resources frequently make a workforce transition from a first workforce sector to a second workforce sector. One common example is that of military personnel migrating from the public sector to the private sector when a service commitment ends or as a temporary transition to gain experience in the private sector before returning to the public sector. Typically, in a public-sector entity such as, for example, a military branch, a form of worker classification may be used internally to classify or describe skills and experience of human resources. In the private sector, however, numerous other nomenclatures and taxonomies may be utilized to classify or describe skills and experience of human resources. Workforce transitions from the first workforce sector to the second workforce sector are thus exceedingly difficult, particularly when human resources migrate back and forth between the first workforce sector and the second workforce sector as part of a career plan.

### SUMMARY OF THE INVENTION

In one embodiment, a method includes configuring a labor pool, the labor pool including a plurality of human resources in a first workforce sector. The configuration of a labor pool includes storing human-resource information. In addition, the method includes configuring a plurality of business entities operating in a second workforce sector that is distinct from the first workforce sector. The configuration of a plurality of business entities includes storing job-opening information for a plurality of job openings. Further, the method includes normalizing the labor pool to a human-capital management (HCM) taxonomy via at least a portion of the human-resource information. Additionally, the method includes normalizing the plurality of job openings to the HCM taxonomy via at least a portion of the job-opening information. The method also includes facilitating a redeployment of at least one human resource in the normalized labor pool from the first workforce sector to the second workforce sector. The facilitating includes matching the at least one human resource to at least one job opening in the normalized plurality of job openings. The method is performed via one or more computers having a processor and memory.

In another embodiment, a computer-program product includes a computer-usable medium having computer-readable program code embodied therein, the computer-readable program code adapted to be executed to implement a method. The method includes configuring a labor pool, the labor pool including a plurality of human resources in a first workforce sector. The configuration of a labor pool includes storing human-resource information. In addition, the method includes configuring a plurality of business entities operating in a second workforce sector that is distinct from the first workforce sector. The configuration of a plurality of business entities includes storing job-opening information for a plurality of job openings. Further, the method includes normalizing the labor pool to a human-capital management (HCM) taxonomy via at least a portion of the human-resource information. Additionally, the method includes normalizing the plurality of job openings to the HCM taxonomy via at least a portion of the job-opening information. The method also includes facilitating a redeployment of at least one human resource in the normalized labor pool from the first workforce sector to the second workforce sector. The facilitating includes matching the at least one human resource to at least one job opening in the normalized plurality of job openings.

The above summary of the invention is not intended to represent each embodiment or every aspect of the present invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1A illustrates a system that may be used to ingest, classify and leverage information for a subject-matter domain;

FIG. 1B illustrates various hardware or software components that may be resident and executed on a subject-matter-domain server;

FIG. 2 illustrates a flow that may be used to ingest, classify and leverage information for the subject-matter domain;

FIG. 3 illustrates an exemplary HCM language library;

FIG. 4 illustrates an exemplary HCM master taxonomy;

FIG. 5 illustrates exemplary database tables for a HCM master taxonomy;

FIG. 6 illustrates a raw-data data structure that may encapsulate raw data from an input record;

FIG. 7 illustrates an exemplary process for a parsing-and-mapping engine;

FIG. 8A illustrates an exemplary parsing flow that may be performed by a parsing-and-mapping engine;

FIG. 8B illustrates an exemplary parsed data record;

FIG. 9 illustrates a spell-check flow that may be performed by a parsing-and-mapping engine;

FIG. 10 illustrates an abbreviation flow that may be performed by a parsing-and-mapping engine;

FIG. 11A illustrates an inference flow that may be performed by a parsing-and-mapping engine;

FIG. 11B illustrates a graph that may utilized in various embodiments;

FIG. 12 illustrates an exemplary multidimensional vector;

FIG. 13 illustrates an exemplary process that may be performed by a similarity-and-relevancy engine;

FIG. 14 illustrates an exemplary process that may be performed by an attribute-differential engine;

FIG. 15 illustrates a system that may facilitate redeployment of human resources;

FIG. 16 illustrates a system that may facilitate redeployment of human resources;

FIG. 17 illustrates a system that may facilitate redeployment of human resources;

FIG. 18 illustrates a high-level functional view of a bid process;

FIG. 19A illustrates a project bid management system;

FIG. 19B illustrates a project bid management system;

FIG. 20 illustrates exemplary functionality for creating a bid request utilizing a bid template;

FIG. 21 illustrates exemplary subcontracting-entity (SCE) enablement and management;

FIG. 22 illustrates a system with particular focus on an exemplary applicant tracking system;

FIG. 23 illustrates a system that may facilitate workforce transitions between two workforce sectors; and

FIG. 24 illustrates a system that may be operable to track and model a human-resource career path that crosses workforce sectors.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be constructed as limited to the embodiments set forth herein; rather, the embodiments are provided so that this disclosure will be thorough and complete, and will fully convey the scope of the invention to those skilled in the art.

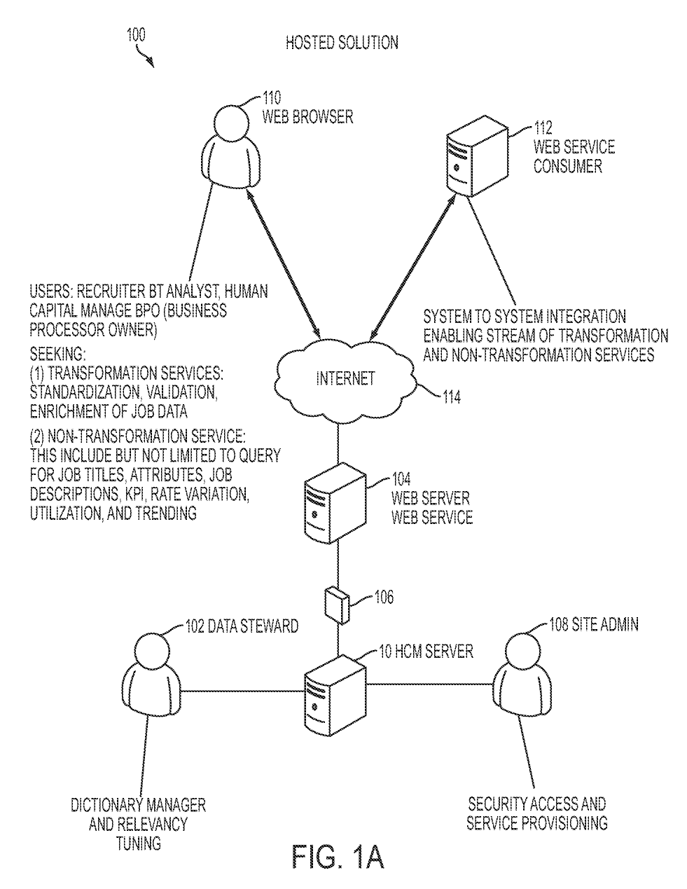

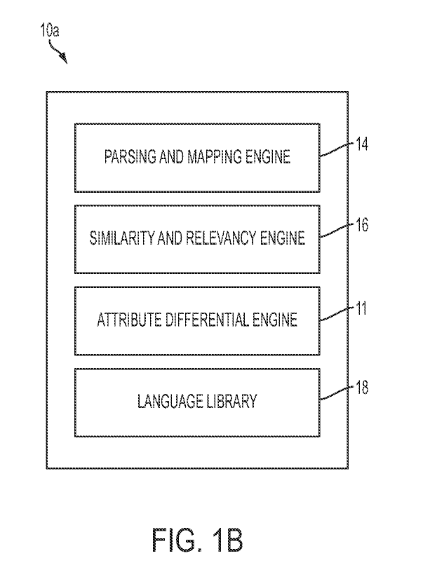

FIG. 1A illustrates a system 100 that may be used to ingest, classify and leverage information for a subject-matter domain. The system 100 may include, for example, a subject-matter-domain server 10, a data steward 102, a web server 104, a network switch 106, a site administrator 108, a web browser 110, a web-service consumer 112 and a network 114. In various embodiments, the web server 104 may provide web services over the network 114, for example, to a user of the web browser 110 or the web-service consumer 112. In a typical embodiment, the provided web services are enabled by the subject-matter-domain server 10. The web server 104 and the subject-matter-domain server are typically communicably coupled via, for example, the network switch 106. The data steward 102 may maintain and provide subject-matter-expertise resident on the subject-matter-domain server 10. In a typical embodiment, the site administrator may, for example, define and implement security policies that control access to the subject-matter-domain server 10. Exemplary functionality of the web server 104 and the subject-matter-domain server 10 will be described in more detail with respect to the ensuing FIGURES.

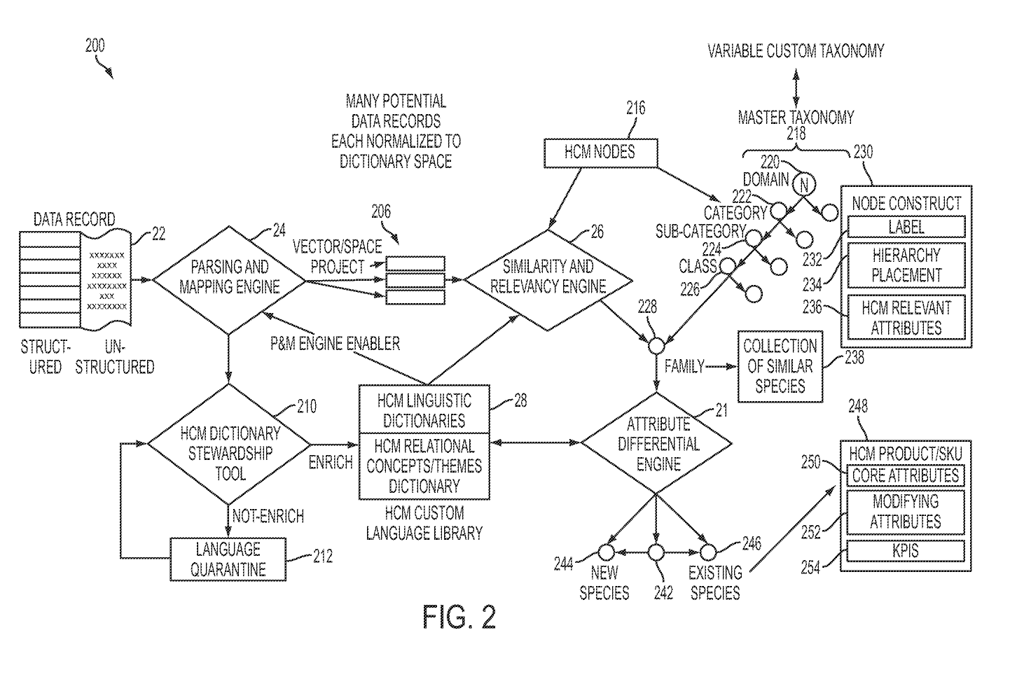

FIG. 1B illustrates various hardware or software components that may be resident and executed on a subject-matter-domain server 10a. In various embodiments, the subject-matter-domain server 10a may be similar to the subject-matter-domain server 10 of FIG. 1A. In a typical embodiment, the subject-matter-domain server 10a may include a parsing-and-mapping engine 14, a similarity-and-relevancy engine 16, an attribute-differential engine 11 and a language library 18. Exemplary embodiments of the parsing-and-mapping engine 14, the similarity-and-relevancy engine 16, the attribute-differential engine 11 and the language library 18 will be discussed with respect to FIG. 2 and the ensuing Figures.

FIG. 2 illustrates a flow 200 that may be used to ingest, classify and leverage information for the subject-matter domain. As will be described in more detail in the foregoing, in a typical embodiment, a language library 28 enables numerous aspects of the flow 200. In a typical embodiment, the language library 28 is similar to the language library 18 of FIG. 1B. The language library 28, in a typical embodiment, includes a collection of dictionaries selected and enriched via expertise in the subject-matter domain. In some embodiments, for example, the subject-matter domain may be human-capital management (HCM). In a typical embodiment, a set of subject dictionaries within the collection of dictionaries collectively define a vector space for the subject-matter domain. Other dictionaries may also be included within the collection of dictionaries in order to facilitate the flow 200. For example, one or more contextual dictionaries may provide context across the set of subject dictionaries. In various embodiments, the language library 28, via the collection of dictionaries, is operable to encapsulate and provide access to knowledge, skill and know-how concerning, for example, what words and phrases of the input record 22 may mean in the subject-matter domain.

The flow 200 typically begins with an input record 22 for ingestion and classification. In various embodiments, the input record 22 may be either a structured record or an unstructured record. As used herein, a structured record is a record with pre-defined data elements and known mappings to the vector space for the subject-matter domain. Conversely, as used herein, an unstructured record is a record that lacks pre-defined data elements and/or known mappings to the vector space. Thus, the input record 22 may be, for example, a database, a text document, a spreadsheet or any other means of conveying or storing information. Substantively, the input record 22 typically contains information that it is desirable to classify, in whole or in part, into a master taxonomy 218. In one embodiment, for example, résumés, job descriptions and other human-capital information may be classified into a human-capital-management (HCM) master taxonomy.

A parsing-and-mapping engine 24 typically receives the input record 22 and operates to transform the input record 22 via the language library 28. The parsing-and-mapping engine 24 is typically similar to the parsing-and-mapping engine 14 of FIG. 1B. In a typical embodiment, the parsing-and-mapping engine 24 may parse the input record 22 into linguistic units. Depending on, inter alia, whether the input record 22 is a structured record or an unstructured record, various methodologies may be utilized in order to obtain the linguistic units. The linguistic units may be, for example, words, phrases, sentences or any other meaningful subset of the input record 22. In a typical embodiment, the parsing-and-mapping engine 24 projects each linguistic unit onto the vector space. The projection is typically informed by the language library 28, which is accessed either directly or via a dictionary-stewardship tool 210. Although illustrated separately in FIG. 2, in various embodiments, the dictionary-stewardship tool 210 and the language quarantine 212 may be part of the language library 28.

The dictionary-stewardship tool 210 generally operates to identify and flag “noise words” in the input record 22 so that the noise words may be ignored. Noise words may be considered words that have been predetermined to be relatively insignificant such as, for example, by inclusion in a noise-words dictionary. For example, in some embodiments, articles such as ‘a’ and ‘the’ may be considered noise words. In a typical embodiment, noise words are not removed from the input record 22 but instead are placed in a language quarantine 212 and ignored for the remainder of the flow 200.

The dictionary-stewardship tool 210 also is typically operable to place into the language quarantine 212 linguistic units that are not able to be enriched by the language library 28. In some embodiments, these linguistic units are not able to be enriched because no pertinent information concerning the linguistic units is able to be obtained from the language library 28. In a typical embodiment, the dictionary-stewardship tool 210 may track the linguistic units that are not able to be enriched and a frequency with which the linguistic units appear. As the frequency becomes statistically significant, the dictionary-stewardship tool 210 may flag such linguistic units for possible future inclusion in the language library 28.

The parsing-and-mapping engine 24 generally projects the linguistic unit onto the vector space to produce a multidimensional vector 206. Each dimension of the multidimensional vector 206 generally corresponds to a subject dictionary from the set of subject dictionaries in the language library 28. In that way, each dimension of the multidimensional vector 206 may reflect one or more possible meanings of the linguistic unit and a level of confidence in those possible meanings.

A similarity-and-relevancy engine 26, in a typical embodiment, is operable to receive the multidimensional vector 206, reduce the number of possible meanings for the linguistic units and begin classification of the linguistic units in the master taxonomy 218. The similarity-and-relevancy engine is typically similar to the similarity-and-relevancy engine 16 of FIG. 1B. The master taxonomy 218 includes a plurality of nodes 216 that, in various embodiments, may number, for example, in the hundreds, thousands or millions. The master taxonomy 218 is typically a hierarchy that spans a plurality of levels that, from top to bottom, range from more general to more specific. The plurality of levels may include, for example, a domain level 220, a category level 222, a subcategory level 224, a class level 226, a family level 228 and a species level 238. Each node in the plurality of nodes 216 is typically positioned at one of the plurality of levels of the master taxonomy 218.

Additionally, each node in the plurality of nodes 216 may generally be measured as a vector in the vector space of the subject-matter domain. In various embodiments, the vector may have direction and magnitude in the vector space based on a set of master data. The set of master data, in various embodiments, may be data that has been reliably matched to ones of the plurality of nodes 216 in the master taxonomy 218 by experts in the subject-matter domain. One of ordinary skill in the art will appreciate that, optimally, the set of master data is large, diverse and statistically normalized. Furthermore, as indicated by a node construct 230, each node in the plurality of nodes 216 may have a label 232, a hierarchy placement 234 that represents a position of the node in the master taxonomy 218 and attributes 236 that are relevant to the subject-matter domain. The attributes 236 generally include linguistic units from data in the set of master data that have been reliably matched to a particular node in the plurality of nodes 216.

The similarity-and-relevancy engine 26 typically uses a series of vector-based computations to identify a node in the plurality of nodes 216 that is a best-match node for the multidimensional vector 206. In addition to being a best match based on the series of vector-based computations, in a typical embodiment, the best-match node must also meet certain pre-defined criteria. The pre-defined criteria may specify, for example, a quantitative threshold for accuracy or confidence in the best-match node.

In a typical embodiment, the similarity-and-relevancy engine 26 first attempts to identify the best-match node at the family level 228. If none of the nodes in the plurality of nodes 216 positioned at the family level 228 meets the predetermined criteria, the similarity-and-relevancy engine 26 may move up to the class level 226 and again attempt to identify the best-match node. The similarity-and-relevancy engine 26 may continue to move up one level in the master taxonomy 218 until the best-match node is identified. As will be described in more detail below, when the master taxonomy is based on a large and diverse set of master data, it is generally a good assumption that the similarity-and relevancy engine 26 will be able to identify the best-match node at the family level 228. In that way, the similarity-and-relevancy engine 26 typically produces, as the best-match node, a node in the plurality of nodes 216 that comprises a collection of similar species at the species level 238 of the master taxonomy 218. In a typical embodiment, the collection of similar species may then be processed by an attribute-differential engine 21.

In a typical embodiment, each node at the species level 238 may have a product key 248 that defines the node relative to a spotlight attribute. The product key 248 may include, for example, a set of core attributes 250, a set of modifying attributes 252 and a set of key performance indicators (KPIs) 254. The spotlight attribute, in a typical embodiment, is an attribute in the set of core attributes 250 that is of particular interest for purposes of distinguishing one species from another species. For example, in a human-capital-management master taxonomy for a human-capital-management subject-matter domain, the spotlight attribute may be a pay rate for a human resource. By way of further example, in a life-insurance master taxonomy for a life-insurance subject-matter domain, the spotlight attribute may be a person's life expectancy.

The core attributes 250 generally define a node at the species level 238. The modifying attributes 252 are generally ones of the core attributes that differentiate one species from another. The KPIs 254 are generally ones of the modifying attributes that significantly affect the spotlight attribute and therefore may be considered to statistically drive the spotlight attribute. In a typical embodiment, the attribute-differential engine 21 is operable to leverage the KPIs 254 in order to compare an unclassified vector 242 with each species in the collection of similar species. The unclassified vector 242, in a typical embodiment, is the multidimensional vector 206 as modified and optimized by the similarity-and-relevancy engine 26.

In a typical embodiment, the attribute-differential engine 21 is operable to determine whether the unclassified vector 242 may be considered a new species 244 or an existing species 246 (i.e., a species from the collection of similar species). If the unclassified vector 242 is determined to be the existing species 244, the unclassified vector 242 may be so classified and may be considered to have the spotlight attribute for the existing species 244. If the unclassified vector 242 is determined to be the new species 246, the new species 244 may be defined using the attributes of the unclassified vector 242. A spotlight attribute for the new species 244 may be defined, for example, as a function of a degree of similarity, or distance, from a most-similar one of the collection of similar species, the distance being calculated via the KPIs 254.

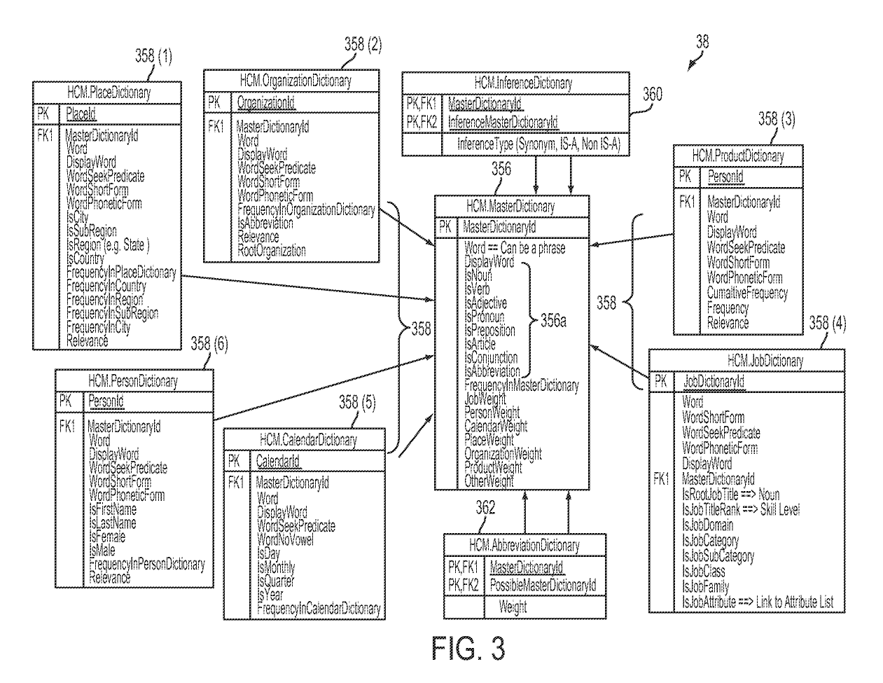

FIGS. 3-14 illustrate exemplary embodiments that utilize a human-capital management (HCM) vector space and leverage expertise in a HCM subject-matter domain. As one of ordinary skill in the art will appreciate, HCM may involve, for example, the employment of human capital, the development of human capital and the utilization and compensation of human capital. One of ordinary skill in the art will appreciate that these exemplary embodiments with respect to HCM are presented solely to provide examples as to how various principles of the invention may be applied and should not be construed as limiting.

FIG. 3 illustrates a HCM language library 38. In various embodiments, the HCM language library 38 may be similar to the language library 28 of FIG. 2 and the language library 18 of FIG. 1B. The HCM language library 38 typically includes a HCM master dictionary 356, an abbreviation dictionary 362, an inference dictionary 360 and a plurality of subject dictionaries 358 that, in a typical embodiment, collectively define the HCM vector space. The plurality of subject dictionaries 358 may include a place dictionary 358(1), an organization dictionary 358(2), a product dictionary 358(3), a job dictionary 358(4), a calendar dictionary 358(5) and a person dictionary 358(6). For example, the plurality of subject dictionaries 358 may include, respectively, names of places (e.g., “California”), names of organizations or business that may employ human capital (e.g., “Johnson, Inc,.”), names of products (e.g., “Microsoft Windows”), job positions (e.g., “database administrator”), terms relating to calendar dates (e.g., “November”) and human names (e.g., “Jane” or “Smith”). In a typical embodiment, the abbreviation dictionary 362, the inference dictionary 360 and, for example, a noise words dictionary may be considered HCM-contextual dictionaries because each such dictionary provides additional context across the plurality of subject dictionaries.

In a typical embodiment, the HCM master dictionary 356 is a superset of the abbreviation dictionary 362, the inference dictionary 360 and the plurality of subject dictionaries 358. In that way, the HCM master dictionary 356 generally at least includes each entry present in the abbreviation dictionary 362, the inference dictionary 360 and the plurality of subject dictionaries 358. The HCM master dictionary 356 may, in a typical embodiment, include a plurality of Boolean attributes 356a that indicate parts of speech for a linguistic unit. The plurality of Boolean attributes 356a may indicate, for example, whether a linguistic unit is a noun, verb, adjective, pronoun, preposition, article, conjunction or abbreviation. As illustrated in FIG. 3, each of the plurality of subject dictionaries 358 may also include relevant Boolean attributes.

In a typical embodiment, the HCM master dictionary 356, the abbreviation dictionary 362, the inference dictionary 360 and the plurality of subject dictionaries 358 may be created and populated, for example, via a set of HCM master data. The set of HCM master data, in various embodiments, may be data that has been input into the HCM language library 38, for example, by experts in the HCM subject-matter domain. In some embodiments, standard dictionary words and terms from various external dictionaries may be integrated into, for example, the plurality of subject dictionaries 358.

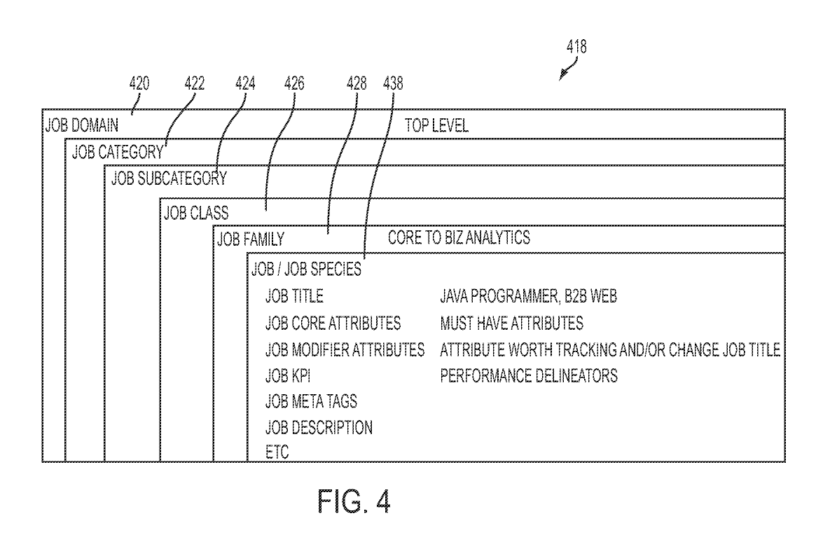

FIG. 4 illustrates a HCM master taxonomy 418 that may be used, for example, to classify human-capital information such as, for example, résumés, job descriptions and the like. In various embodiments, the HCM master taxonomy 418 may be similar to the master taxonomy 218 of FIG. 2. The HCM master taxonomy 418 typically includes a job-domain level 420, a job-category level 422, a job-subcategory level 424, a job-class level 426, a job-family level 428 and a job-species level 438.

In various embodiments, the HCM master taxonomy 418 and the HCM language library 38 are configured and pre-calibrated, via HCM subject-matter expertise, to a set of HCM master data in manner similar to that described with respect to the language library 28 and the master taxonomy 218 of FIG. 2. More particularly, the set of HCM master data may include a series of records such as, for example, job descriptions, job titles, résumé segments, and the like. As described with respect to the master taxonomy 218 of FIG. 2, each node in the HCM master taxonomy 418 may be measured as a vector in the HCM vector space of the HCM subject-matter domain. Therefore, each node in the HCM master taxonomy 418 may have direction and magnitude in the HCM vector space based on the set of HCM master data. The set of HCM master data, in various embodiments, may be data that has been reliably matched to nodes of the HCM master taxonomy 418 by experts in the HCM subject-matter domain. One of ordinary skill in the art will appreciate that, optimally, the set of HCM master data is large, diverse and statistically normalized.

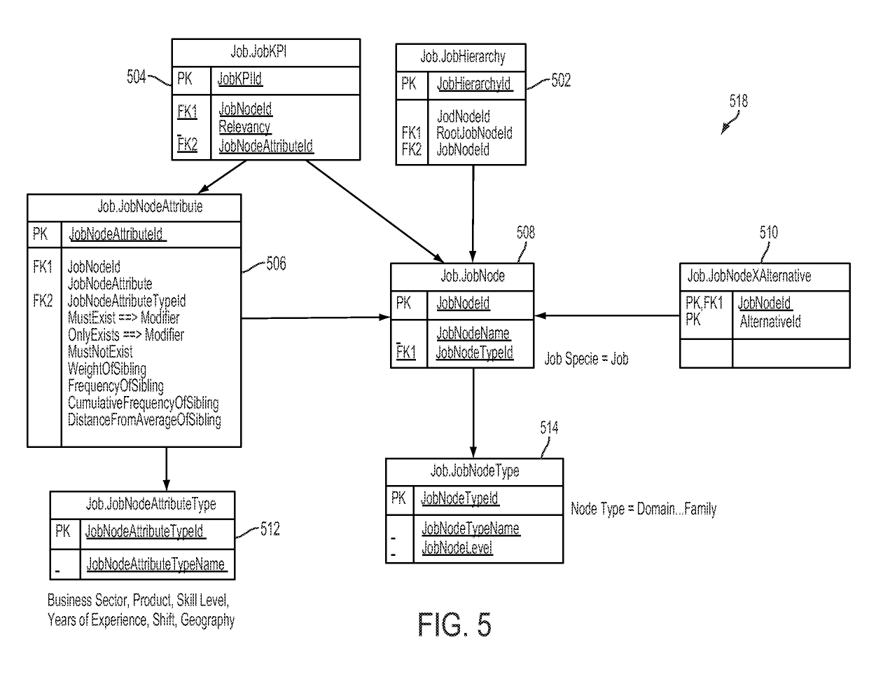

FIG. 5 illustrates exemplary database tables for a HCM master taxonomy 518. In a typical embodiment, a job hierarchy 502 may include one or more job nodes 508. Each of the one or more job nodes 508 may typically have a job-node type 514. The job-node type 514 may be, for example, one of the following described with respect to FIG. 4: the job-domain level 420, the job-category level 422, the job-subcategory level 424, the job-class level 426, the job-family level 428 and the job-species level 438. Each of the one or more job nodes 508 may have one or more job-node attributes 506. In a typical embodiment, one or more of the job-node attributes 506 may be KPIs for a spotlight attribute of the one or more job nodes 508. In a typical embodiment, each of the job-node attributes 506 may have a job-node-attribute type 512. A job-node alternate 510 may, in a typical embodiment, provide an alternate means of identifying the job node 508.

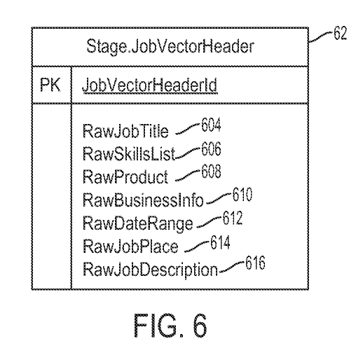

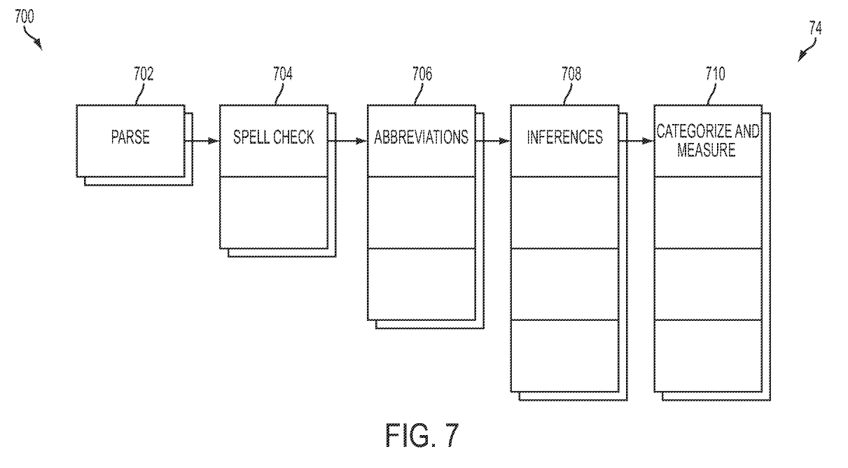

FIG. 6 illustrates a raw-data data structure 62 that may encapsulate raw data from an input record such as, for example, the input record 22 of FIG. 2. The raw data may be converted and conformed to the raw-data data structure 62 so that the raw data is usable by a parsing-and-mapping engine such as, for example, the parsing-and-mapping engine 24 of FIG. 2. In a typical embodiment, the raw-data data structure 62 may include, for example, a job-title attribute 604, a skills-list attribute 606, a product attribute 608, an organization-information attribute 610, a date-range attribute 612, a job-place attribute 614 and a job-description attribute 616. Various known technologies such as, for example, optical character recognition (OCR) and intelligent character recognition (ICR) may be utilized to convert the raw data into the raw-data data structure 62. One of ordinary skill in the art will recognize that various known technologies and third-party solutions may be utilized to convert the raw data into the raw-data data structure 702 of FIG. 7.

FIG. 7 illustrates an exemplary process 700 for a parsing-and-mapping engine 74. In various embodiments, the parsing-and-mapping engine 74 may be similar to the parsing-and-mapping engine 24 of FIG. 2 and the parsing-and-mapping engine 14 of FIG. 1B. In a typical embodiment, the process 700 is operable to transform an input record such as, for example, the input record 22 of FIG. 2 via, for example the HCM language library 38 of FIG. 3. At a parsing step 702, the parsing-and-mapping engine 74 parses raw data such as, for example, an instance of the raw-data data structure 62 of FIG. 6, into linguistic units. In a typical embodiment, steps 704, 706, 708 and 710 proceed individually with respect to each linguistic unit of the linguistic units parsed at the step 702.

At spell-check step 704, the parsing-and-mapping engine 74 may perform a spell check of a linguistic unit from the linguistic units that were parsed at the step 702. At an abbreviation step 706, if the linguistic unit is an abbreviation, the parsing-and-mapping engine 74 attempts to identify one or more meanings for the abbreviation. At an inference step 708, the parsing-and-mapping engine 74 identifies any inferences that may be made either based on the linguistic unit or products of the steps 704 and 706. At step 710, as a cumulative result of steps 702, 704, 706 and 708, the linguistic unit is categorized, for example, into one or more of a plurality of subject dictionaries such as, for example, the plurality of subject dictionaries 358 of FIG. 3. Additionally, a confidence level, or weight, of the linguistic unit may be measured. In that way, the parsing-and-mapping engine 74 is operable to transform the raw data via, for example, the HCM language library 38 of FIG. 3.

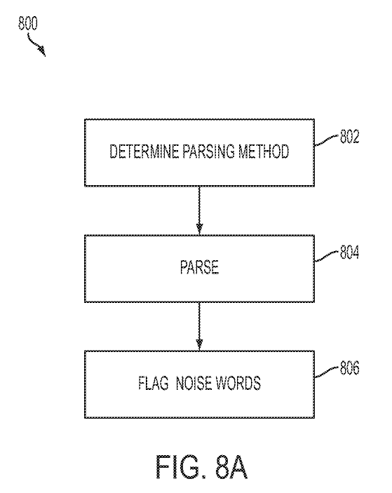

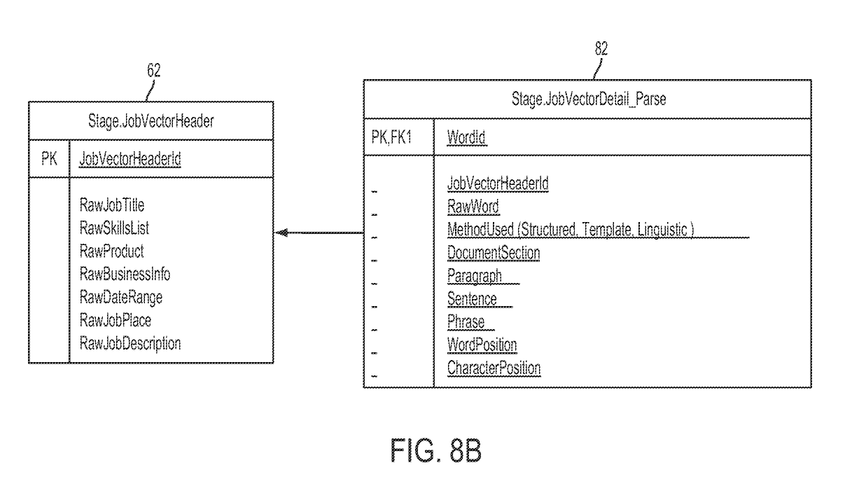

FIG. 8A illustrates a parsing flow 800 that may be performed during a parsing step such as, for example, the parsing step 702 of FIG. 7. At step 802, a parsing method is determined. As noted with respect to FIG. 2, an input record such as, for example, the input record 22 of FIG. 2 may be a structured record or an unstructured record. A structured record is a record with pre-defined data elements and known mappings, in this case, to the HCM vector space. Therefore, if an input record such as, for example, the input record 22 of FIG. 2, is a structured record, the known mappings may be followed for purposes of parsing.

However, if an input record such as, for example, the input record 22 of FIG. 2, is an unstructured record, other parsing methods may be utilized such as, for example, template parsing and linguistic parsing. Template parsing may involve receiving data, for example, via a form that conforms to a template. In that way, template parsing may involve identifying linguistic units based on placement of the linguistic units on the form. One of ordinary skill in the art will appreciate that a variety of third-party intelligent data capture (IDC) solutions may be utilized to enable template parsing.

Linguistic parsing may be used to parse an unstructured record when, for example, template parsing is either not feasible or not preferred. In a typical embodiment, linguistic parsing may involve referencing a HCM language library such as, for example, the HCM language library 38 of FIG. 3. Using a HCM language library such as, for example, the HCM language library 38 of FIG. 3, the parsing-and-mapping engine 74 of FIG. 7 may identify each linguistic unit in the unstructured record and determine each linguistic unit's part of speech. One of ordinary skill in the art will recognize that a linguistic unit may be a single word (e.g., “database”) or a combination of words that form a logical unit (e.g., “database administrator”). In a typical embodiment, linguistic parsing is tantamount to creating a linguistic diagram of the unstructured record.

At step 804 of FIG. 8A, the parsing-and-mapping engine 74 may parse an input record such as, for example, the input record 22 of FIG. 2, according to the parsing method determined at step 802. In typical embodiment, the step 804 may result in a plurality of parsed linguistic units. At step 806, the parsing-and-mapping engine 74 may flag noise words in the input record using, for example, the HCM language library 38 of FIG. 3. In various embodiments, the flagging of noise words may occur in a manner similar to that described with respect to FIG. 2. After step 806, the parsing flow 800 is complete.

FIG. 8B illustrates an exemplary parsed data record 82 that, in various embodiments, may be produced by the parsing flow 800. In a typical embodiment, the parsed data record 82 includes the plurality of parsed linguistic units produced by the parsing flow 800. The plurality of parsed linguistic units may be, for example, words. As shown, in a typical embodiment, the parsed data record 82 may be traced to the raw-data data structure 702 of FIG. 7.

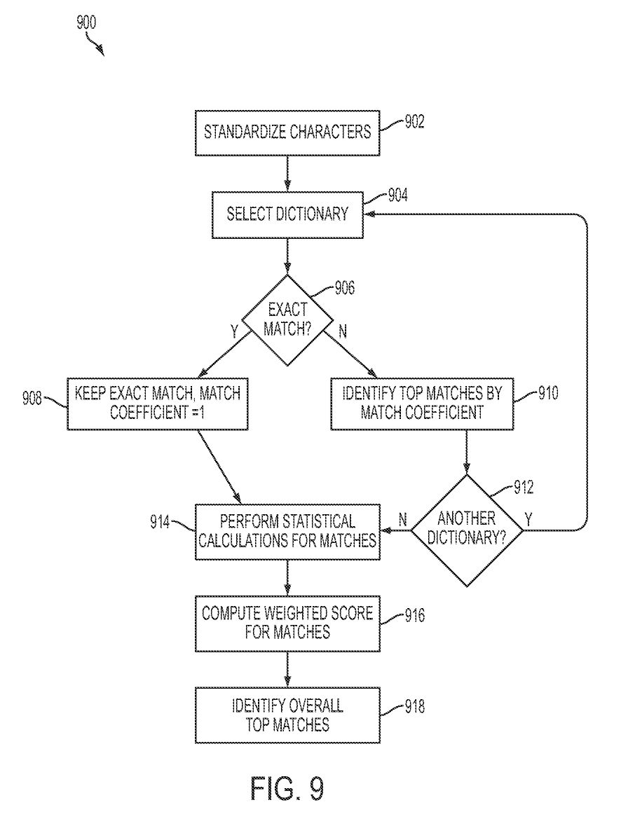

FIG. 9 illustrates a spell-check flow 900 that may be performed by the parsing-and-mapping engine 74 during, for example, the spell-check step 704 of FIG. 7. Typically, the spell-check flow 900 begins with a parsed linguistic unit, for example, from the plurality of parsed linguistic units produced by the parsing flow 800 of FIG. 8A. Table 1 includes an exemplary list of spell-check algorithms that may be performed during the step 902, which algorithms will be described in more detail below.

TABLE 1

| SPELL-CHECK ALGORITHM | RESULT |
|---|---|
| Character Standardization | Translates a linguist unit into a |
| | standard character set. |
| Exact Match | Returns either 0 or 1. |
| Edit-Distance Ratio | Returns a value between 0 and 1, |
| | inclusive. |
| Double-Metaphone Ratio | Returns a value between 0 and 1, |
| | inclusive. |

At step 902, the parsing-and-mapping engine 74 may perform a character-standardization algorithm on the parsed linguistic unit. For example, one of ordinary skill in the art will appreciate that an “em dash,” an “en dash,” a non-breaking hyphen and other symbols are frequently used interchangeably in real-world documents even though each is a distinct symbol. In various embodiments, performing the character-standardization algorithm operates to translate the parsed linguistic unit into a standard character set that removes such ambiguities. In that manner, the efficiency and effectiveness of the spell-check flow 900 may be improved.

At step 904, the parsing-and-mapping engine may select a subject dictionary for searching. In a typical embodiment, the subject dictionary selected for searching may be one of a plurality of subject dictionaries such as, for example, the plurality of subject dictionaries 358 of FIG. 3. In various embodiments, the parsing-and-mapping engine 74 may check the plurality of subject dictionaries 358 of FIG. 3 in a predetermined order as a performance optimization. The performance optimization is typically based on a premise that an exact match in a higher-ranked dictionary is much more significant than an exact match in a lower-ranked dictionary. Therefore, an exact match in a higher-ranked dictionary may eliminate any need to search other dictionaries in the plurality of subject dictionaries 358.

Depending on a particular objective, various orders may be utilized. For example, in some embodiments, the parsing and mapping engine 74 may check the plurality of subject dictionaries 358 in the following order: the job dictionary 358(4), the product dictionary 358(3), the organization dictionary 358(2), the place dictionary 358(1), the calendar dictionary 358(5) and the person dictionary 358(6). In these embodiments, if an exact match for the parsed linguistic unit is found in the job dictionary 358(4), that match is used and no further dictionaries are searched. In that way, computing resources may be preserved.

At step 906, the parsing-and-mapping engine 74 may attempt to identify an exact match for the parsed linguistic unit in the subject dictionary selected for searching at the step 904. In a typical embodiment, the parsing-and-mapping engine 74 of FIG. 7 may perform an exact-match algorithm for the parsed linguistic unit against the subject dictionary selected for searching. In a typical embodiment, the exact-match algorithm returns a one if an exact match for the parsed linguistic unit is found in the dictionary selected for searching and returns a zero otherwise.

If, at the step 906, an exact match is found for the parsed linguistic unit in the subject dictionary selected for searching, in a typical embodiment, the spell-check flow 900 proceeds to step 908. At the step 908, the exact match is kept and no other spell-check algorithm need be performed with respect to that dictionary. Additionally, the exact match may be assigned a match coefficient of one. The match coefficient will be discussed in more detail below. From the step 908, the spell-check flow 900 proceeds directly to step 914.

If the exact-match algorithm returns a zero for the parsed linguistic unit at the step 906, the spell-check flow 900 proceeds to step 910. At the step 910, the parsing-and-mapping engine 74 may identify top matches in the subject dictionary selected for searching via a match coefficient. As used herein, a match coefficient may be considered a metric that serves as a measure of a degree to which a first linguistic unit linguistically matches a second linguistic unit. As part of calculating the match coefficient, an edit-distance-ratio algorithm and a metaphone-ratio algorithm may be performed.

As one of ordinary skill in the art will appreciate, a formula for calculating an edit-distance ratio between a first linguistic unit (i.e., ‘A’) and a second linguistic unit (i.e., ‘B’) may be expressed as follows:

Max_Length=Max(A.Length,B.Length)

Edit-Distance Ratio(A,B)=(Max_Length−Edit Distance(A,B))/Max_Length

An edit distance between two linguistic units may be defined as a minimum number of edits necessary to transform the first linguistic unit (i.e., ‘A’) into the second linguistic unit (i.e., ‘B’). A length of the first linguistic unit (i.e., ‘A’) may be defined as the number of characters contained in the first linguistic unit. Similarly, a length of the second linguistic unit (i.e., ‘B’) may be defined as the number of characters contained in the second linguistic unit. One of ordinary skill in the art will recognize that the only allowable “edits” for purposes of calculating an edit distance are insertions, deletions or substitutions of a single character. One of ordinary skill in the art will further recognize that the formula for edit-distance ratio expressed above is exemplary in nature and, in various embodiments, may be modified or optimized without departing from the principles of the present invention. In that way, an edit-distance ratio between the parsed linguistic unit and a target linguistic unit in the subject dictionary selected for searching may be similarly calculated.

As one of ordinary skill in the art will appreciate, a formula for calculating a double-metaphone ratio may be expressed as follows:

Double-Metaphone Ratio(A,B)=Edit-Distance Ratio(A.Phonetic_Form,B.Phonetic_Form)

As one of ordinary skill in the art will appreciate, the double-metaphone ratio algorithm compares a phonetic form for the first linguistic unit (i.e., ‘A’) and the second linguistic unit (i.e., ‘B’) and returns a floating number between 0 and 1 that is indicative of a degree to which the first linguistic unit and the second linguistic unit phonetically match. In various embodiments, the double-metaphone ratio algorithm may vary as, for example, as to how A.Phonetic_Form and B.Phonetic_Form are determined and as to how an edit-distance ratio between A.Phonetic_Form and B.Phonetic_Form are calculated. In that way, a double-metaphone ratio between the parsed linguistic unit and a target linguistic unit in the subject dictionary selected for searching may be similarly calculated.

For example, as one of ordinary skill in the art will recognize, the double-metaphone algorithm may determine a primary phonetic form for a linguistic unit and an alternate phonetic form for the linguistic unit. Therefore, in some embodiments, it is possible for both the parsed linguistic unit and a target linguistic unit in the subject dictionary selected for searching to each yield a primary phonetic form and an alternate phonetic form. If the primary phonetic form and the alternate phonetic form for both the parsed linguistic unit and the target linguistic unit in the subject dictionary selected for searching are considered, one of ordinary skill in the art will recognize that four edit-distance ratios may be calculated. In some embodiments, the double-metaphone ratio may be a maximum of the four edit-distance ratios. In other embodiments, the double-metaphone ratio may be an average of the four edit-distance ratios. In still other embodiments the double-metaphone ratio may be a weighted average of the four edit-distance ratios such as, for example, by giving greater weight to ratios between primary phonetic forms.

In some embodiments, greater accuracy for the double-metaphone algorithm may be achieved by further considering a double-metaphone ratio for a backwards form of the parsed linguistic unit. The backwards form of the parsed linguistic unit is, in a typical embodiment, the parsed linguistic unit with its characters reversed. As discussed above, the double-metaphone ratio for the backwards form of the parsed linguistic unit may be considered via, for example, an average or weighted average with the double-metaphone ratio for the parsed linguistic unit in its original form. One of ordinary skill in the art will recognize that any formulas and methodologies for calculating a double-metaphone ratio expressed above are exemplary in nature and, in various embodiments, may be modified or optimized without departing from the principles of the present invention.

Still referring to the step 910 of FIG. 9, in a typical embodiment, an overall edit-distance ratio and an overall double-metaphone ratio may be calculated using, for example, one or more methodologies discussed above. Using the double-metaphone ratio and the edit-distance ratio, a match coefficient may be calculated, for example, as follows:

Match Coefficient(A,B)=(Exact-Match(A,B)+Edit-Distance Ratio(A,B)+Double-Metaphone Ratio(A,B))/3

As one of ordinary skill in the art will recognize, by virtue of reaching the step 910, no exact match for the raw linguistic typically exists in the dictionary selected for searching. Therefore, “Exact-Match (A, B)” will generally be zero.

In various embodiments, a result of the step 910 is that the parsing-and-mapping engine 74 identifies the top matches, by match coefficient, in the subject dictionary selected for searching. In a typical embodiment, any matches that have a match coefficient that is less than a dictionary coefficient for the subject dictionary selected for searching may be removed from the top matches. The dictionary coefficient, in a typical embodiment, is a metric representing an average edit distance between any two nearest neighbors in a dictionary. For example, a formula for the dictionary coefficient may be expressed as follows:

Dictionary Coefficient=(½)+(Average_Edit_Distance(Dictionary)/2)

In this manner, in terms of edit distance, it may be ensured that the top matches match the parsed linguistic unit at least as well as any two neighboring linguistic units in the subject dictionary selected for searching, on average, match each other.

In a typical embodiment, after the step 910, the spell-check flow 900 proceeds to step 912. At the step 912, the parsing-and-mapping engine 74 may determine whether, for example, others of the plurality of subject dictionaries 358 of FIG. 3 should be searched according to the predetermined order discussed above. If so, the spell-check flow 900 returns to the step 904 for selection of another subject dictionary according to the predetermined order. Otherwise, the spell-check flow 900 proceeds to step 914.

At the step 914, the parsing-and-mapping engine 74 may perform statistical calculations on a set of all top matches identified across, for example, the plurality of subject dictionaries 358 of FIG. 3. As will be apparent from discussions above, the set of all top matches may include, in a typical embodiment, exact matches and matches for which a match coefficient is greater-than-or-equal-to an applicable dictionary coefficient. Table 2 describes a plurality of frequency metrics that may be calculated according to a typical embodiment.

TABLE 2

| FREQUENCY METRIC | DESCRIPTION |
|---|---|
| Local Frequency | Number of occurrences of a |
| | particular linguistic unit from a |
| | particular subject dictionary in a |
| | set of master data. |
| Max Frequency | Maximum of all local frequencies |
| Total Frequency | Sum of all local frequencies |

In a typical embodiment, a local frequency may be calculated for each top match of the set of all top matches. As mentioned above with respect to FIG. 3, in a typical embodiment, the HCM language library 38 of FIG. 3 may be configured and pre-calibrated, via HCM subject-matter expertise, to the set of HCM master data. Therefore, in various embodiments, the local frequency may represent a total number of occurrences of a particular top match from the set of all top matches in a corresponding subject dictionary from the plurality of subject dictionaries 358 of FIG. 3. In a typical embodiment, the local frequency may already be stored in the corresponding subject dictionary. Therefore, a max frequency may be identified by determining which top match from the set of all top matches has the largest local frequency. A total frequency may be calculated by totaling local frequencies for each top match of the set of all top matches.

From the step 914, the spell-check flow 900 proceeds to step 916. At the step 916, the parsing-and-mapping engine 74 may compute a weighted score for each top match in the set of all top matches. In various embodiments, the weighted score may be calculated as follows:

Weighted Score=Match Coefficient*Local_Frequency/Total Frequency

One of ordinary skill in the art will note that the weighted score yields a value between 0 and 1. In that way, the parsing-and-mapping engine may weight a particular top match's match coefficient based on a frequency of that top match relative to frequencies of other top matches.

From step 916, the spell-check flow 900 proceeds to step 918. At the step 918, the parsing-and-mapping engine 74 may identify overall top matches in the set of all top matches. In a typical embodiment, the overall top matches in the set of all top matches are those matches that meet one or more predetermined statistical criteria. An exemplary pre-determined statistical criterion is as follows:

Local Frequency>=Max_Frequency−(3*Standard_Deviation(Local_Frequencies))

Thus, in some embodiments, the overall top matches may include each top match in the set of all top matches for which the local frequency meets the exemplary pre-determined statistical criterion. After the step 918, the spell-check flow 900 ends. In a typical embodiment, the process 900 may be performed for each of the plurality of parsed linguistic units produced by the parsing flow 800 of FIG. 8A.

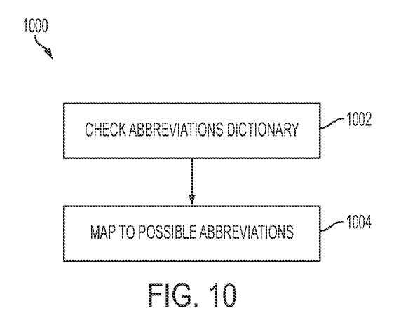

FIG. 10 illustrates an abbreviation flow 1000 that may be performed by the parsing-and-mapping engine 74 during, for example, the abbreviation step 706 of FIG. 7. It should be noted that, in a typical embodiment, if it can be determined that none of the overall total matches from the spell-check flow 900 and the parsed linguistic unit are abbreviations, then the process 1000 need not be performed. This may be determined, for example, by referencing the HCM master dictionary of FIG. 3 and a part-of-speech identified, for example, during the parsing flow 800 of FIG. 8B. At step 1002, the parsing-and-mapping engine 74 may check an abbreviation dictionary such as, for example, the abbreviation dictionary 362 of FIG. 3. In a typical embodiment, the abbreviation dictionary may be checked with respect to each parsed linguistic unit in the plurality of parsed linguistic units produced by the parsing flow 800 of FIG. 8A and each of the overall top matches from the spell-check flow 900.

At step 1004, the parsed linguistic unit and each of the overall top matches are mapped to any possible abbreviations listed, for example, in the abbreviation dictionary 362 of FIG. 3. One of ordinary skill in the art will recognize that the abbreviation dictionary 362, in a typical embodiment, may yield possible abbreviations, for example, across the plurality of subject dictionaries 358 of FIG. 3. In a typical embodiment, a weighted score for each of the possible abbreviations may be obtained, for example, from the abbreviation dictionary 362. Following the step 1004, the abbreviation flow 1000 ends.

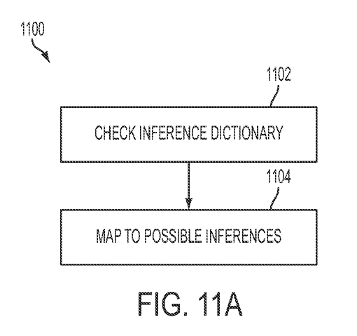

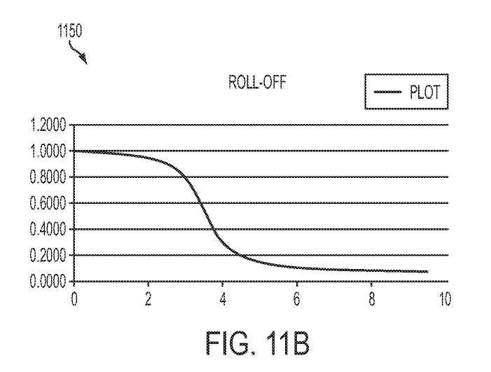

FIG. 11A illustrates an inference flow 1100 that may be performed by the parsing-and-mapping engine 74 during, for example, the inference step 708 of FIG. 7. At step 1102, the parsing-and-mapping engine 74 may check an inference dictionary such as, for example, the inference dictionary 360 of FIG. 3. In various embodiments, with respect to a parsed linguistic unit in the plurality of parsed linguistic units from the parsing flow 800 of FIG. 8A, the parsed linguistic unit, the overall top matches from the spell-check flow 900 of FIG. 9 and the possible abbreviations from the abbreviation flow 1000 of FIG. 10 are all checked in the inference dictionary 360 of FIG. 3. To facilitate the discussion of the inference flow 1100, the parsed linguistic unit, the overall top matches from the spell-check flow 900 of FIG. 9 and the possible abbreviations from the abbreviation flow 1000 of FIG. 10 will be collectively referenced as source linguistic units. Table 3 lists exemplary relationships that may be included in the inference dictionary 360 of FIG. 3. Other types of relationships are also possible and will be apparent to one of ordinary skill in the art.

TABLE 3

| RELATIONSHIP | RANKING |
|---|---|
| “IS-A” Relationship | Rank = 1 |
| Synonym | Rank = 1 |
| Frequency-Based Relationship | Rank from 1 to n based on |
| | frequency |

As shown in Table 3, the inference dictionary 360 of FIG. 3 may yield, for example, “IS-A” relationships, synonyms and frequency-based relationships. In a typical embodiment, an “IS-A” relationship is a relationship that infers a more generic linguistic unit from a more specific linguistic unit. For example, a linguistic unit of “milk” may have an “IS-A” relationship with “dairy product” since milk is a dairy product. “IS-A” relationships may be applied in a similar manner in the HCM subject-matter domain. In a typical embodiment, a synonym relationship is a relationship based on one linguistic unit being synonymous, in at least one context, with another linguistic unit. A frequency-based relationship is a relationship based on two linguistic units being “frequently” related, typically in a situation where no other relationship can be clearly stated. With a frequency-based relationship, the inference dictionary 360 typically lists a frequency for the relationship, for example, from the set of master data for the HCM language library 38 of FIG. 3. In a typical embodiment, the inference dictionary 360 of FIG. 3 may list one or more relationships for each of the source linguistic units.

At step 1104, each of the source linguistic units are mapped to any possible inferences, or inferred linguistic units, from the inference dictionary 360. In a typical embodiment, “IS-A” relationships and synonym relationships are each given a rank of one. Additionally, in a typical embodiment, frequency-based relationships are ranked from one to n based on, for example, a frequency number provided in the inference dictionary 360. The inferred linguistic units are, in a typical embodiment, retained and stored with the source linguistic units, that is, the parsed linguistic unit, the overall top matches from the spell-check flow 900 of FIG. 9 and the possible abbreviations from the abbreviation flow 1000 of FIG. 10. After the step 1104, the inference flow 1100 ends.

FIG. 11B illustrates a graph 1150 that may utilized in various embodiments. One of ordinary skill in the art will recognize that the graph 1150 is a Cauchy distribution. In a typical embodiment, the graph 1150 may be utilized to convert, for example, a rank on the x-axis to a weighted score between zero and one on the y-axis. For example, the graph 1150 may be utilized to convert and store a rank associated with each of the inferred linguistic units produced in the process 1100 of FIG. 11A into a weighted score. One of ordinary skill in the art will appreciate that, in various embodiments, other distributions may be used in place of the Cauchy distribution.

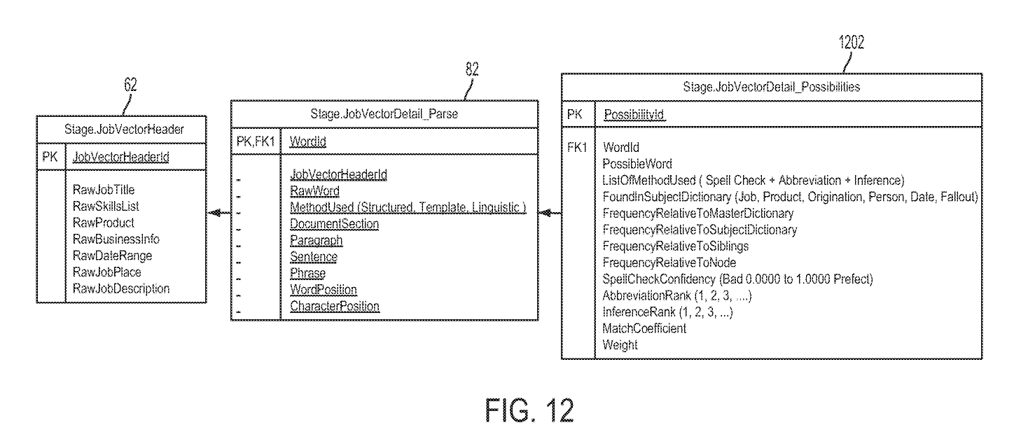

FIG. 12 illustrates an exemplary multidimensional vector 1202 that may, in various embodiments, be produced as a result of the parsing flow 800, the spell-check flow 900, the abbreviation flow 1000 and the inference flow 1100. In various embodiments, the multidimensional vector 1202 may be similar to the multidimensional vector 206 of FIG. 2. As shown, in a typical embodiment, the multidimensional vector 1202 may be traced to the raw-data data structure 702 of FIG. 7 and the parsed data record 82 of FIG. 8B.

In various embodiments, the multidimensional vector 1202 represents a projection of the plurality of parsed linguistic units produced in the parsing flow 800 of FIG. 8A onto the HCM vector space. The multidimensional vector 1202 generally includes the plurality of parsed linguistic units produced in the parsing flow 800 of FIG. 8A. The multidimensional vector also generally includes, for each parsed linguistic unit in the plurality of parsed linguistic units: each of the overall top matches from the spell-check flow 900 of FIG. 9, each of the possible abbreviations from the abbreviation flow 1000 of FIG. 10 and each of the inferred linguistic units from the inference flow 1100 as dimensions of the multidimensional vector 1202. Each dimension of the multidimensional vector 1202 is thus a vector that has direction and magnitude (e.g., weight) relative to the HCM vector space. More particularly, each dimension of the multidimensional vector 1202 typically corresponds to a subject dictionary, for example, from the plurality of subject dictionaries 358. In a typical embodiment, each dimension of the multidimensional vector 1202 thereby provides a probabilistic assessment as to one or more meanings of the plurality of parsed linguistic units in the HCM subject-matter domain. In that way, each dimension of the multidimensional vector 1202 may reflect one or more possible meanings of the plurality of parsed linguistic units and a level of confidence, or weight, in those possible meanings.

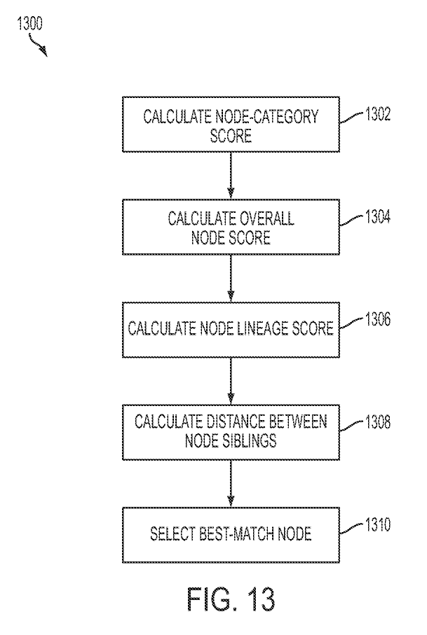

FIG. 13 illustrates an exemplary process 1300 that may be performed by a similarity-and-relevancy engine 1326. In various embodiments, the similarity-and-relevancy engine 1326 may be similar to the similarity-and-relevancy engine 26 of FIG. 2 and the similarity-and-relevancy engine 16 of FIG. 1B. At step 1302, subject to various performance optimizations that may be implemented, a node-category score may be calculated for each of a plurality of subject dictionaries, for each node of a HCM master taxonomy between a domain level and a family level and across the plurality of parsed linguistic units produced, for example, by the parsing flow 800 of FIG. 8A. In various embodiments, the plurality of subject dictionaries may be, for example, the plurality of subject dictionaries 358 of FIG. 3 and the HCM master taxonomy may be, for example, the HCM master taxonomy 418 of FIG. 4. Further, in a typical embodiment, the node-category score may be calculated for each node of the HCM master taxonomy 418 beginning at the job-domain level 420 through the job-family level 428.

In a typical embodiment, each of the overall top matches from the spell-check flow 900 of FIG. 9, each of the possible abbreviations from the abbreviation flow 1000 of FIG. 10 and each of the inferred linguistic units from the inference flow 1100 may represent a possible meaning of a particular parsed linguistic unit. Further, as noted above, each such possible meaning typically has a weighted score indicating a degree of confidence in the possible meaning. In a typical embodiment, calculating the node-category score at the step 1302 may involve, first, identifying a highest-weighted possible meaning at a dimension of the multidimensional vector for a particular one of the parsed linguistic units. The highest-weighted possible meaning is generally a possible meaning with the highest weighted score.

Typically, the highest-weighted possible meaning is identified for each parsed linguistic unit in the plurality of parsed linguistic units produced in the parsing flow 800 of FIG. 8A. In a typical embodiment, the node-category score involves summing the weighted scores for the highest-weighted possible meaning for each of the plurality of parsed linguistic units produced in the parsing flow 800 of FIG. 8A. In that way, a node-category score may be calculated, for example, for a particular dimension of the multidimensional vector 1202 of FIG. 12. In a typical embodiment, the step 1302 may be repeated for each dimension of the multidimensional vector 1202 of FIG. 12. In various embodiments, following the step 1302, a node-category score is obtained for each node of the HCM master taxonomy 418 from the job-domain level 420 through the job-family level 428.

Various performance optimizations may be possible with respect to the step 1302. For example, one of ordinary skill in the art will recognize that a master taxonomy such as, for example, the HCM master taxonomy 418 may conceivably include thousands or millions of nodes. Therefore, in various embodiments, it is beneficial to reduce a number of nodes for which a node-category score must be calculated. In some embodiments, the number of nodes for which the node-category score must be calculated may be reduced by creating a stop condition when, for example, a node-category score is zero. In these embodiments, all nodes beneath a node having a node-category score of zero may be ignored under an assumption that the node-category score for these nodes is also zero.

For example, if a node-category score of zero is obtained for a node at the job-domain level 420, all nodes beneath that node in the HCM master taxonomy 418, in a typical embodiment, may be ignored and assumed to similarly have a node-category score of zero. In various embodiments, this optimization is particularly effective, for example, at domain, category and subcategory levels of a master taxonomy such as, for example, the master taxonomy 418. Additionally, in various embodiments, utilization of this optimization may result in faster and more efficient operation of a similarity-and-relevancy engine such as, for example, the similarity- and relevancy engine 1326. One of ordinary skill in the art will recognize that other stop conditions are also possible and are fully contemplated as falling within the scope of the present invention.

In various embodiments, performance of the step 1302 may also be optimized through utilization of bit flags. For example, in a typical embodiment, a node in the HCM master taxonomy 418, hereinafter a flagged node, may have a bit flag associated with a node attribute for the flagged node. In a typical embodiment, the bit flag may provide certain information regarding whether the associated node attribute may also be a node attribute for the flagged node's siblings. As one of ordinary skill in the art will appreciate, all nodes that immediately depend from the same parent may be considered siblings. For example, with respect to the HCM master taxonomy 418 of FIG. 4, all nodes at the job-family level 438 that immediately depend from a single node at the job-family level 428 may be considered siblings.

In a typical embodiment, the bit flag may specify: (1) an action that is taken if a particular condition is satisfied; and/or (2) an action that is taken if a particular condition is not satisfied. For example, in various embodiments, the bit flag may specify: (1) an action that is taken if the associated node attribute matches, for example, a dimension of the multidimensional vector 1202 of FIG. 12; and/or (2) an action that is taken if the associated node attribute does not match, for example, a dimension of the multidimensional vector 1202 of FIG. 12. Table 4 provides a list of exemplary bit flags and various actions that may be taken based thereon. One of ordinary skill in the art will recognize that other types of bit flags and actions are also possible.

TABLE 4

| | | ACTION IF VECTOR |
|---|---|---|
| | ACTION IF VECTOR | DOES NOT MATCH |
| BIT FLAG | MATCHES ATTRIBUTE | ATTRIBUTE |
| Attribute Only Exists | For flagged node, add | No action. |
| | weighted score to the node- | |
| | category score; for all siblings, | |
| | node-category score = 0. | |
| Attribute Must Exist | For flagged node, add | For flagged node, node- |
| | weighted score to the node- | category score = 0; for all |
| | category score; for siblings, no | siblings, node-category score = |
| | action. | 0. |
| Attribute Can Exist | For flagged node, add | No action. |
| | weighted score to the node- | |
| | category score; for siblings, no | |
| | action. | |
| Attribute Must Not Exist | For flagged node, node- | No action. |
| | category score = 0; for all | |
| | siblings, node-category score = | |
| | 0. | |

For example, as shown in Table 4, in a typical embodiment, the similarity-and-relevancy engine 1326 may utilize an attribute-only-exists bit flag, an attribute-must-exist bit flag, an attribute-can-exist bit flag and an attribute-must-not-exist bit flag. In some embodiments, every node in a master taxonomy such as, for example, the HCM master taxonomy 418 may have bit flag associated with each node attribute. In these embodiments, the bit flag may be one of the four bit flags specified in Table 4.

In a typical embodiment, the attribute-only-exist bit flag indicates that, among the flagged node and the flagged node's siblings, only the flagged node has the associated attribute. Therefore, according to the attribute-only-exist bit flag, if the associated node attribute matches, for example, a dimension of the multidimensional vector 1202 of FIG. 12, the similarity-and-relevancy engine 1326 may skip the flagged node's siblings for purposes of calculating a node-category score as part of the step 1302 of FIG. 13. Rather, the similarity-and-relevancy engine 1326 may take the action specified in Table 4 under “Action if Vector Matches Attribute.” Otherwise, no action is taken. In this manner, the similarity-and-relevancy engine 1326 may proceed more quickly and more efficiently.

In a typical embodiment, the attribute-must-exist flag indicates that, in order for the flagged node or any of the flagged node's siblings to be considered to match a dimension of a multidimensional vector such as, for example, the multidimensional vector 1202 of FIG. 12, the associated attribute must independently match the dimension of the multidimensional vector. If the associated attribute does not independently match the dimension of the multidimensional vector, the similarity-and-relevancy engine 1326 may skip the flagged node's siblings for purposes of calculating a node-category score as part of the step 1302 of FIG. 13. Rather, the similarity-and-relevancy engine 1326 may take the action specified in Table 4 under “Action if Vector Does Not Match Node Attribute.” Otherwise, the similarity-and-relevancy engine 1326 may take the action specified in Table 4 under “Action if Vector Matches Attribute.” In this manner, the similarity-and-relevancy engine 1326 may proceed more quickly and more efficiently.

In a typical embodiment, the attribute-can-exist bit flag indicates that the associated node attribute may exist but provides no definitive guidance as to the flagged node's siblings. According to the attribute-can-exist flag, if the associated node attribute matches, for example, a dimension of the multidimensional vector 1202 of FIG. 12, the similarity-and-relevancy engine 1326 may take the action specified in Table 4 under “Action if Vector Matches Attribute.” Otherwise, no action is taken.

In a typical embodiment, the attribute-must-not-exist bit flag indicates that neither the flagged node nor the flagged node's siblings have the associated node attribute. Therefore, according to the attribute-must-not-exist bit flag, if the associated node attribute matches, for example, a dimension of the multidimensional vector 1202 of FIG. 12, the similarity-and-relevancy engine 1326 may skip the flagged node's siblings for purposes of calculating a node-category score as part of the step 1302 of FIG. 13. Rather, the similarity-and-relevancy engine 1326 may take the action specified in Table 4 under “Action if Vector Matches Attribute.” Otherwise, no action is taken. In this manner, the similarity-and-relevancy engine 1326 may proceed more quickly and more efficiently.

Following the step 1302, the process 1300 proceeds to step 1304. At the step 1304, an overall node score may be calculated for each node of the HCM master taxonomy 418 of FIG. 4 from the job-domain level 420 through the job-family level 428. In a typical embodiment, the overall node score may be calculated, for example, by performing the following calculation for a particular node:

Overall_Node_Score=Square-Root((C*S₁)̂2+(C*S₂)̂2+ . . . +(C*Sₙ)̂2)

In the formula above, C represents a category weight, S₁ and S₂ each represent a node-category score and ‘n’ represents a total number of node-category scores for the particular node. In a typical embodiment, a category weight is a constant factor that may be used to provide more weight to node-category weights for certain dimensions of the multidimensional vector 1202 of FIG. 12 than others. Table 5 provides a list of exemplary category weights that may be utilized in various embodiments.

TABLE 5

| SUBJECT | WEIGHT |
|---|---|
| Job | 1 |
| Product | 0.86 |
| Organization | 0.66 |
| Person | 0.32 |
| Place | 0.20 |
| Date | 0.11 |

From the step 1304, the process 1300 proceeds to step 1306. At the step 1306, the similarity-and-relevancy engine 1326 may calculate a node lineage score for each node at a particular level, for example, of the HCM master taxonomy 418 of FIG. 4. In a typical embodiment, the node lineage score is initially calculated for each node at the job-family level 428 of the HCM master taxonomy 418 of FIG. 4. In a typical embodiment, a maximum node lineage score may be identified and utilized in subsequent steps of the process 1300. For example, a node lineage score may be expressed as follows:

Node_Lineage_Score_{Node}=Square-Root((Node_Level_Weight_{Node}*Overall_Node_Score_{Node})̂2+ . . . +(Node_Level_Weight_{Domain}*Overall_Node_Score_{Domain})̂2)

As part of the formula above, calculating the node lineage score for a particular node (i.e., Node_Lineage_Score_{Node}) may involve calculating a product of a node-level weight for the particular node (i.e., Node_Level_Weight_{Node}) and an overall node score for the particular node (i.e., Overall_Node_Score_{Node}). Typically, as shown in the formula above, a product is similarly calculated for each parent of the particular node up to a domain level such as, for example, the job-domain level 420. Therefore, a plurality of products will result. In a typical embodiment, as indicated in the formula above, each of the plurality of products may be squared and subsequently summed to yield a total. Finally, in the formula above, a square-root of the total may be taken in order to obtain the node lineage score for the node (i.e., Node_Lineage_Score_{Node}).

In various embodiments, as indicated in the exemplary formula above, the node lineage score may utilize a node-level weight. The node-level weight, in a typical embodiment, is a constant factor that may be used to express a preference for overall node scores of nodes that are deeper, for example, in, the HCM master taxonomy 418. For example, Table 6 lists various exemplary node-level weights that may be used to express this preference. One of ordinary skill in the art will recognize that other node-level weights may also be utilized without departing from the principles of the present invention.

TABLE 6

| NODE | |
|---|---|
| LEVEL | WEIGHT |
| Domain | 1 |
| Category | 2 |
| Sub-Category | 3 |
| Class | 4 |
| Family | 5 |

From the step 1306, the process 1300 proceeds to step 1308. At the step 1308, the similarity-and-relevancy engine 1326 may calculate a distance between the maximum node-lineage score identified at the step 1306 and each sibling of a node having the maximum node-lineage score. For simplicity of description, the node having the maximum node-lineage score will be referenced as a candidate node and a sibling of the candidate node will be referenced as a sibling node. In various embodiments, an objective of the step 1306 is to use the distance between the candidate node and each sibling node to help ensure that the candidate node more closely matches, for example, the multidimensional vector 1202 of FIG. 12 than it does any sibling node. In other words, the step 1306 may provide a way to ensure a certain level confidence in the candidate node.

In a typical embodiment, for a particular sibling node, the step 1308 generally involves processing node attributes of the particular sibling node as a first hypothetical input into the similarity-and-matching engine 1326 solely with respect to the candidate node. In other words, the step 1302, the step 1304 and the 1306 may be performed with the hypothetical input in such a manner that ignores all nodes except for the candidate node. The first hypothetical input, in a typical embodiment, yields a first hypothetical node-lineage score that is based on a degree of match between the node attributes of the sibling node and the candidate node.

Similarly, in a typical embodiment, the step 1308 further involves processing node attributes of the candidate node as a second hypothetical input into the similarity-and-matching engine 1326 solely with respect to the candidate node. In other words, the step 1302, the step 1304 and the 1306 may be performed with the second hypothetical input in such a manner that ignores all nodes except for the candidate node. The second hypothetical input, in a typical embodiment, yields a second hypothetical node-lineage score based on a degree of match between the node attributes of the candidate node and the candidate node.

Therefore, in various embodiments, a distance between the candidate node and the particular sibling node may be considered to be the first hypothetical node-lineage score divided by the second hypothetical node-lineage score. Similarly, in various embodiments, a distance between, for example, the multidimensional vector 1202 of FIG. 12 and the candidate node may be considered to be the maximum node-lineage score divided by the second hypothetical node-lineage score. In a typical embodiment, the calculations described above with respect to the particular sibling node may be performed for each sibling node of the candidate node.

From the step 1308, the process 1300 proceeds to step 1310. At the step 1310, a best-match node, for example, for the multidimensional vector 1202 of FIG. 12 may be selected. In a typical embodiment, the candidate node must meet at least one pre-defined criterion in order to be deemed the best-match node. For example, in a typical embodiment, for each sibling node of the candidate node, the distance between the multidimensional vector 1202 of FIG. 12 and the candidate node must be less than the distance between the candidate node and the sibling node. In a typical embodiment, if the at least one pre-defined criterion is not met, the step 1306, the step 1308 and the step 1310 may be repeated one level higher, for example, in the HCM master taxonomy 418 of FIG. 4. For example, if the best-match node cannot be identified at the job-family level 428, the step 1306, the step 1308 and the step 1310 may proceed with respect to the job-class level 426. In a typical embodiment, the HCM master taxonomy 418 is optimized so that, in almost all cases, the best-match node may be identified at the job-family level 428. Therefore, in a typical embodiment, the step 1310 yields a collection of similar species at the job-species level 438, species in the collection of similar species having the best-match node as a parent. Following the step 1310, the process 1300 ends.

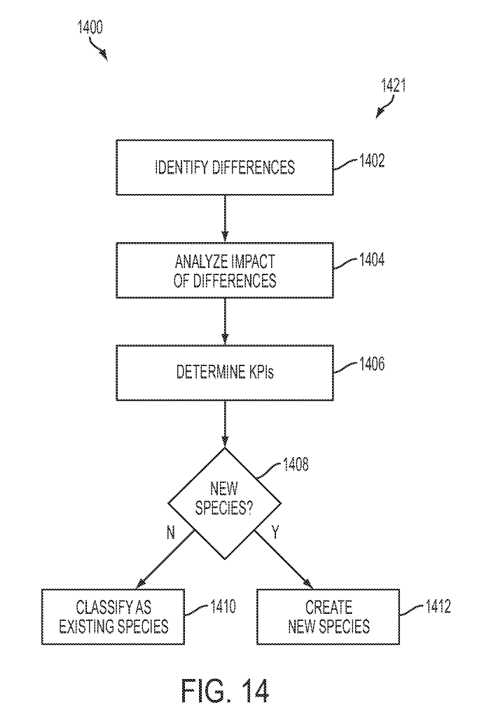

FIG. 14 illustrates an exemplary process 1400 that may be performed by an attribute-differential engine 1421. In various embodiments, the attribute-differential engine 1421 may be similar to the attribute-differential engine 21 of FIG. 2. At step 1402, the attribute-differential engine 1421 may identify differences between node attributes for each species of the collection of similar species produced by the process 1300 of FIG. 13. Identified differences may be similar, for example, to the modifying attributes 252 of FIG. 2. From step 1402, the process 1400 proceeds to step 1404. At the step 1404, an impact of the identified differences may be analyzed relative to a spotlight attribute such as, for example, a pay rate for a human resource. In a typical embodiment, the attribute-differential engine 1421 may statistically measure the impact in the HCM vector space based on, for example, the HCM language library 38. From the step 1404, the process 1400 proceeds to step 1406.

At the step 1406, a set of KPIs may be determined. In a typical embodiment, the set of KPIs may be similar to the set of KPIs 254 of FIG. 2. In a typical embodiment, the set of KPIs may be represent ones of the identified differences that statistically drive, for example, the pay rate for a human resource. From step 1406, the process 1400 proceeds to step 1408.

At the step 1408, the attribute-differential engine 1421 is operable to determine whether, for example, the multidimensional vector 1202 of FIG. 2 may be considered a new species or an existing species (i.e., a species from the collection of similar species). If the multidimensional vector 1202 is determined, based on the set of KPIs, to be an existing species for a particular species in the collection of similar species, the multidimensional vector 1202 may be so classified at step 1410. In that case, the multidimensional vector 1202 may be considered to have, for example, a same pay rate as the particular species. Following the step 1410, the process 1400 ends. However, if at the step 1408 the multidimensional vector 1202 is determined to be a new species, the new species may be created and configured at step 1412. In a typical embodiment, the new species may be configured to have, for example, a pay rate that is calculated as a function of a distance from species in the collection of similar species. Following the step 1412, the process 1400 ends.

In some embodiments, it may be beneficial to utilize, for example, various embodiments described with respect to FIGS. 1-14 to facilitate a redeployment of human resources from participation at an entity in a first workforce sector to employment in a second workforce sector such as, for example, a private sector. In various embodiments, the first workforce sector may be, for example, a public sector. Other possible workforce sectors will be apparent to one of ordinary skill in the art. As one of ordinary skill in the art will appreciate, the private sector is typically a workforce sector that includes business entities that are operated by individuals or groups, usually as a means of enterprise for profit, and are not controlled by government. The public sector is a workforce sector that generally includes enterprises and entities that are operated by a government such as, for example, a military branch, a defense department, and the like.

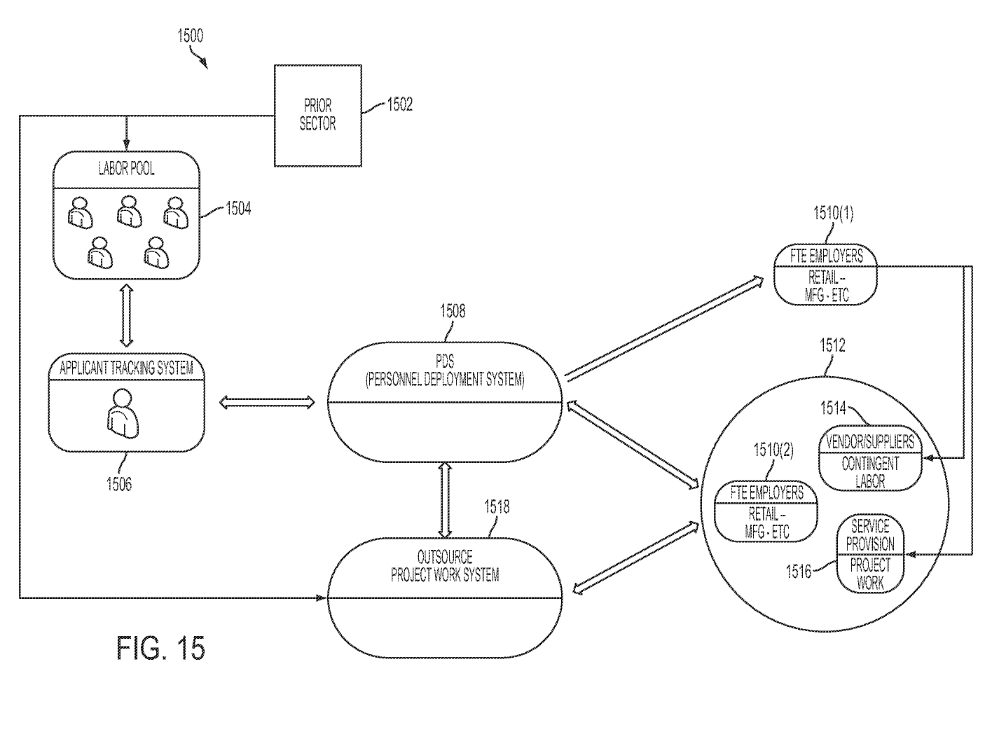

Solely by way of example, as one of ordinary skill will appreciate, military personnel in the United States and other jurisdictions may make a workforce transition, or redeployment, from the public sector to the private sector either when a service commitment ends or as part of an overall career plan in the public sector. Typically, in a public-sector entity such as, for example, a military branch, a form of worker classification may be used internally to classify or describe skills and experience of human resources. In the private sector, however, numerous other nomenclatures and taxonomies may be utilized to describe skills and experience of human resources. In various embodiments, as described with respect to FIGS. 15-17 and 22-24, information from distinct workforce sectors such as, for example, the public sector and the private sector may be normalized so as to facilitate redeployment of human resources.

Additionally, continuing the above example, a military branch and other public-sector entities often are buyers in a project-work sphere. The project-work sphere, as used herein, refers to a practice of outsourcing projects to one or more outside entities such as, for example, business entities in the private sector. For example, a military branch or another related public-sector entity, as buyers in a project-work sphere, may outsource projects related to aerospace or weaponry. One of ordinary skill in the art will appreciate that such projects frequently result in substantial economic benefits, for example, for business entities in the private sector to which project work for the projects is awarded.

In various embodiments, it may be advantageous to leverage an entity's status as a buyer in a project-work sphere to encourage entities in another workforce sector to accept redeployment of the buyer's human resources that are scheduled for redeployment, for example, out of the public sector into the private sector. For example, in various embodiments, a military branch may employ human resources that, pursuant to a service commitment or plan or other agreement, periodically or semi-permanently transition to employment in the private sector. In a typical embodiment, the transition to employment in the private sector may be temporary with a planned transition back to the public sector or semi-permanent with the caveat that the human resources may be recalled to the public sector on an as-needed basis.

In addition, in a typical embodiment, the workforce transition to employment in the private sector may be part of a career plan for the human resources. A career plan, in a typical embodiment, is a plan to progressively develop various skills and/or experience in order to gradually transition a human resource into one or more different roles or positions in a workforce sector. A career plan may be utilized in order to help the human resources develop skills that are useful to a role or a prospective role in the public sector. In this manner, in various embodiments, the military branch would benefit from an ability to track and control how human resources are redeployed and to ensure that the human resources are in fact redeployed to the private sector. Thus, in various embodiments, a status as a buyer in a project-work sphere may be leveraged to increase speed and effectiveness of redeployment in another workforce sector such as, for example, the private sector.

FIG. 15 illustrates a system 1500 that may facilitate redeployment of human resources, for example, into the private sector. The system 1500 includes a prior workforce sector 1502, a labor pool 1504, an applicant tracking system 1506, a personnel deployment system (PDS) 1508, a plurality of full-time employee (FTE) employers 1510(1), a project-work sphere 1512, and an outsource system 1518. The project-work sphere 1512 includes a plurality of FTE employers 1510(2), a plurality of vendors 1514 of contingent or temporary labor, and project work 1516.

The labor pool 1504 may include a plurality of human resources that are employed in or otherwise participating within the prior workforce sector 1502. The prior workforce sector 1502 may be, for example, the public sector. In a typical embodiment, participation in the public sector may involve employment by an entity in the public sector such as, for example, employment pursuant to a service commitment for a military branch. Typically, the prior workforce sector 1502 is centrally controlled such as, for example, by a government, a board, or other similar leadership.

The applicant tracking system 1506, in a typical embodiment, is operable to configure and manage the labor pool 1504. As part of configuring the labor pool 1504, the applicant tracking system 1506 typically stores and maintains human-resource information that describes, for example, skills, experience and career plans for each of the plurality of human resources in the labor pool 1504. As part of managing the labor pool 1504, the applicant tracking system 1504 typically adds or removes human resources to the labor pool 1504 as needed.

One of ordinary skill in the art will appreciate that the configuration of the labor pool 1504 may be a dynamic and continuous process. As noted above, transitions or redeployments into the private sector, in various embodiments, may be temporary or semi-permanent so that a return to the public sector is planned or at least possible. Therefore, in a typical embodiment, as the plurality of human resources in the labor pool 1504 develop additional skills and experience in either the prior sector 1502 or the private sector, those skills and the experience may be integrated into the human-resource information for the labor pool 1504. In this manner, in a typical embodiment, the applicant tracking system 1506 is operable to maintain, via the human-resource information, a current snapshot of the labor pool 1504. Thus, as a result, the plurality of human resources in the labor pool 1504 may be more effectively redeployed to the private sector and more effectively utilized in the public sector upon a return to the public sector.

The PDS 1508, in a typical embodiment, is operable to normalize the human-resource information for each of the plurality of human resources in the labor pool 1504 to a master taxonomy such as, for example, the HCM master taxonomy 418 of FIG. 4 and the master taxonomy 218 of FIG. 2. Normalization to, for example, the HCM master taxonomy 418 of FIG. 4 typically involves classification of the human-resource information into a HCM master taxonomy such as for example, the HCM master taxonomy 418 as described, for example, with respect to FIGS. 1-14. In a typical embodiment, the PDS 1508 similarly normalizes job openings in the private sector with the plurality of FTE employers 1510(1).

The plurality of FTE employers 1510(1) generally includes business entities in another workforce sector such as, for example, the private sector. The PDS 1508 typically configures and manages the business entities in the plurality of FTE employers 1510(1). Configuring the business entities in the plurality of FTE employers 1510(1), in a typical embodiment, involves obtaining and storing information related to the business entities that is normalized, for example, to the HCM master taxonomy 418. Management of the business entities typically involves adding and deleting business entities in the plurality of FTE employers 1510(1) and ensuring that the information related to the business entities in the plurality of FTE employers 1510(1) is current.

The plurality of FTE employers 1510(1) and the plurality of FTE employers 1510(2) are depicted separately in FIG. 15 in order to illustrate that, in a typical embodiment, entities in the prior workforce sector 1502 may interact with business entities in the private sector on at least two different levels. In a typical embodiment, on one level, the entities in the prior workforce sector 1502, via the PDS 1508, may interact with the plurality of FTE employers 1510(1) in an attempt to redeploy the plurality of human resources in the labor pool 1504 into the private sector. In a typical embodiment, on another level, the prior workforce sector 1502, via the outsource system 1518, may interact with the plurality of FTE employers 1510(2) in order to outsource the project work 1516. The project work 1516 may include, for example, defense contracts, other government contracts, or research work. Hereinafter, the plurality of FTE employers 1510(1) and the plurality of FTE employers 1510(2) may be collectively referenced as a plurality of FTE employers 1510.

The plurality of FTE employers 1510, in a typical embodiment, may interact with the outsource system 1518, for example, in order to bid for and obtain the project work 1516. The plurality of FTE employers 1510, in a typical embodiment, may further utilize the services of the plurality of vendors 1514 of contingent or temporary labor in order to staff the project work. In various embodiments, interactions between the PDS 1508, the project-work sphere 1512 and the outsource system 1518 operate to optimize redeployment of the plurality of human resources in the labor pool 1504 into the private sector, as described in more detail below.

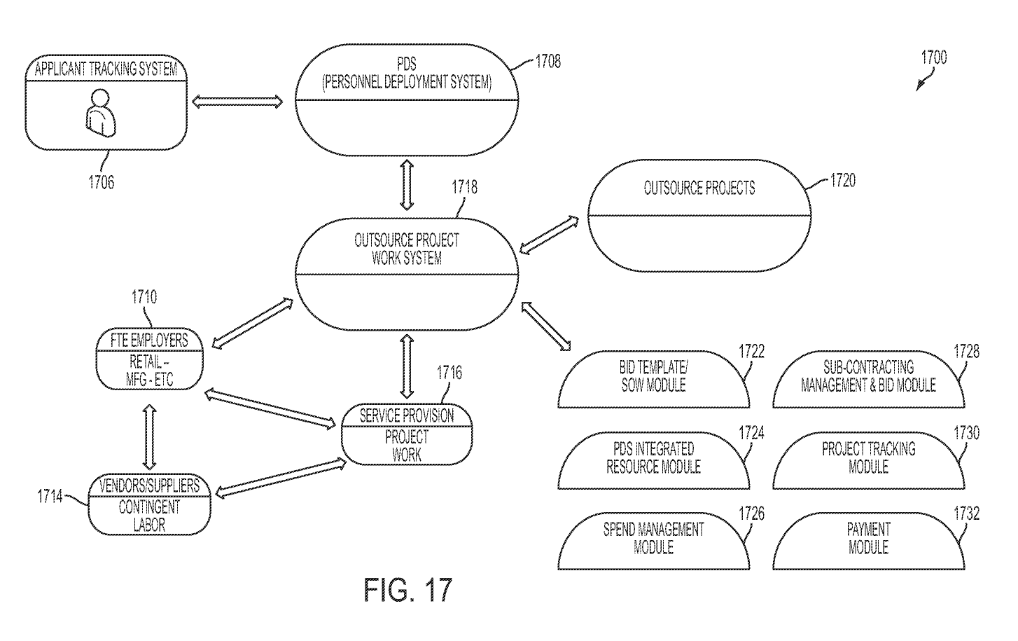

In various embodiments, the outsource system 1518 may be utilized as leverage to award the project work 1516 to ones of the plurality of FTE employers 1510 that employ the plurality of human resources in the labor pool 1504 either as full-time employees or as temporary labor to staff the project work 1516. In that way, in a typical embodiment, redeployment of the plurality of human resources 1504 in the private sector may be optimized via interactions between the PDS 1508, the outsource system 1518 and the project-work sphere 1512. Examples of the optimization will be described in more detail with respect to FIG. 17.

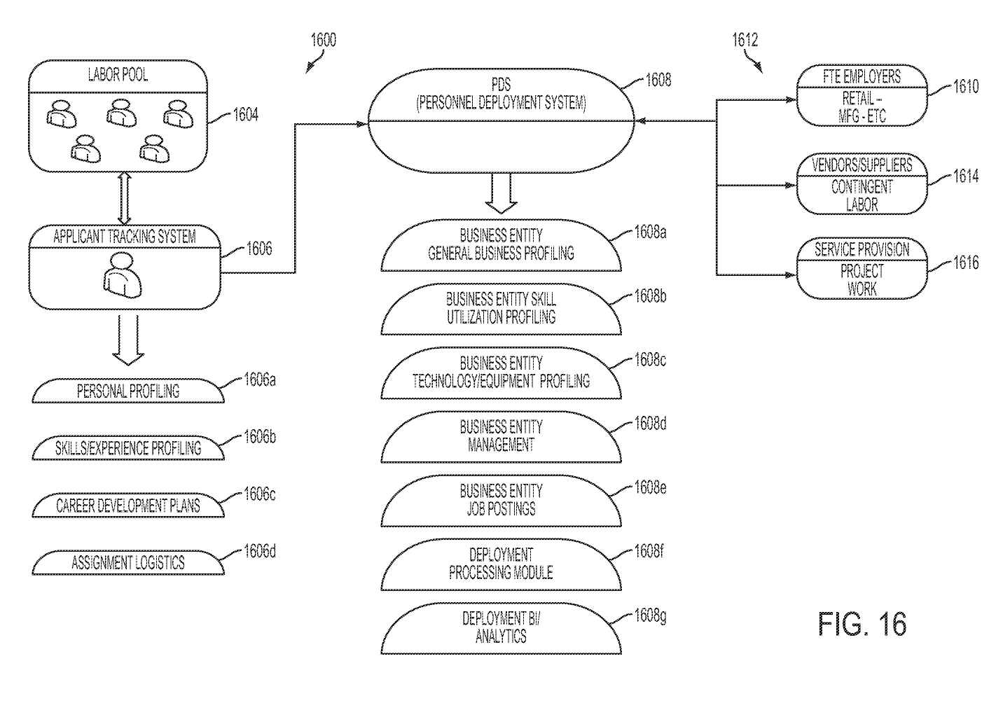

FIG. 16 illustrates a system 1600 that may facilitate redeployment of human resources, for example, into the private sector. The system 1600 includes a labor pool 1604, an applicant tracking system 1606, a PDS 1608 and a project-work sphere 1612. The project-work sphere 1612 includes a plurality of FTE employers 1610, a plurality of vendors 1614 of contingent or temporary labor and project work 1616. In a typical embodiment, the labor pool 1604, the applicant tracking system 1606, the PDS 1608 and the project-work sphere 1612 are similar to the labor pool 1504, the applicant tracking system 1506, the PDS 1508 and the project-work sphere 1512 of FIG. 15, respectively. Further, in a typical embodiment, the plurality of FTE employers 1610, the plurality of vendors 1614 of contingent or temporary labor and the project work 1616 are similar to the plurality of FTE employers 1510, the plurality of vendors 1514 of contingent or temporary labor and the project work 1516 of FIG. 15, respectively.

In a typical embodiment, the applicant tracking system 1606 is operable to configure the labor pool 1604. In a typical embodiment, configuration of the labor pool 1604 may involve obtaining and storing, for each of a plurality of human resources in the labor pool 1604, human-resource information. The human-resource information may include personal-profiling information 1606a, skills/experience information 1606b, career-development plans 1606c and assignment logistics 1606d. As discussed above with respect to the labor pool 1504 of and the applicant tracking system 1506 of FIG. 15, configuration of the labor pool 1604 may be a dynamic and continuous process and thus involve regularly updating and maintaining the obtained and stored human-resource information. Various examples of updating and maintaining the obtained and stored human-resource information will be described with respect to the PDS 1608 below.

The personal-profiling information 1606a may include, for example, objective information regarding strengths, abilities and employment inclinations. The personal-profiling information 1606a may, in some embodiments, be extracted from results of a personal-profiling test administered to the plurality of human resources in the labor pool 1604. The skills/experience information 1606b may include résumé-type information that includes, for example, skills developed, for example, inside and outside of the prior workforce sector 1502 and work history and experience inside and outside of the prior workforce sector 1502. The career-development plans 1606c may include, for example, information related to career goals and desires for the plurality of human resources in the labor pool 1604. In various embodiments, the career goals and desires may be constructed with the benefit of consultation with a career-development counselor or other similar professional. The assignment logistics 1606d may include, for example, one or more desired locations for employment and dates of availability.

In a typical embodiment, the PDS 1608 is operable to configure the plurality of FTE employers 1610. In a typical embodiment, configuration of the plurality of FTE employers 1610 involves performing and storing information related to business-entity general-business profiling 1608a, business-entity skill-utilization profiling 1608b, business-entity technology/equipment profiling 1608c and business-entity management 1608d. Configuration of the plurality of FTE employers 1610, in a typical embodiment, may further involve obtaining and storing business-entity job postings 1608e and generating deployment business intelligence (BI) 1608g. The business-entity job postings 1608e generally include job-opening information for job openings for the plurality of FTE employers 1610. The job-opening information may include, for example, information regarding required skills and experience, job location and other job requirements or descriptions. The PDS 1608 also may include a deployment-processing module 1608f.

The information related to the business-entity general-business profiling 1608a may include any type of data related to a business entity, such as, for example, a business-entity type, geographical locations, industry segmentation, size, spend capacity, etc. The information related to the business-entity skill-utilization profiling 1608b, in a typical embodiment, may include information related to specific skills and sets of skills historically required by a business entity. The information related to the business-entity technology/equipment profiling 1608c may include, for example, information regarding equipment, technologies and products utilized by employees of a business entity in the plurality FTE employers 1610. In a typical embodiment, the information related to the business-entity technology/equipment profiling 1608c may be similar to information contained within the product dictionary 358(3) of FIG. 3.

The information related to the business-entity skill-utilization profiling 1608b and the information related to the business-entity technology/equipment profiling 1608c, in a typical embodiment, may be acquired over time by ingesting job descriptions such as, for example, the business-entity job postings 1608e and classifying the job descriptions into a HCM master taxonomy such as, for example, the HCM master taxonomy 418 of FIG. 4 as described with respect to FIGS. 1-14. In some embodiments, the information related to the business-entity skill-utilization profiling 1608b and the information related to the business-entity technology/equipment profiling 1608c may be based on a set of HCM master data such as, for example, the set of HCM master data to which the HCM language library 38 of FIG. 3 may be configured and pre-calibrated. In other embodiments, the information related to the business-entity skill-utilization profiling 1608b may be directly provided by the business entity.

The business-entity management 1608d may include, for example, functionality to add or delete business entities in the plurality of FTE employers 1610. In various embodiments, the business-entity management 1608d may further include functionality to maintain an accuracy and currency of information related to the business entities in the plurality of FTE employers 1610. For example, in a typical embodiment, the PDS 1608 may periodically prompt a business entity in the plurality of FTE employers 1610 to confirm or update the information related to business-entity general-business profiling 1608a for that business entity. In a typical embodiment, the PDS 1608 may also periodically prompt a business entity in the FTE employers 1610 to update, for example, the business-entity job postings 1608e.

The business-entity job postings 1608e typically represent, for example, job openings for which the plurality of human resources in the labor pool 1604 may apply. In some embodiments, the business-entity job postings 1608e may be provided directly by business entities in the plurality of FTE employers 1610. In other embodiments, the business-entity job postings 1608e may be provided by periodicals (e.g., newspapers, magazines, etc.), Internet web sites and other sources. In a typical embodiment, job-opening information related to the business-entity job postings 1608e may be ingested and classified into a master HCM taxonomy such as, for example, the HCM master taxonomy 418 of FIG. 4 as described with respect to FIGS. 1-14. In that way, the business-entity job postings 1608e may be normalized, for example, to the HCM master taxonomy 418.

The deployment-processing module 1608f, in a typical embodiment, is operable to normalize human-resource information for each of the plurality of human resources in the labor pool 1604 to a master taxonomy such as, for example, the HCM master taxonomy 418 of FIG. 4 and the master taxonomy 218 of FIG. 2. The human-resource information that is normalized may include, for example, the personal-profiling information 1606a, the skills/experience information 1606b and the career-development plans 1606c. Normalization to, for example, the HCM master taxonomy 418 of FIG. 4 typically involves classification of the human-resource information into a HCM master taxonomy such as for example, the HCM master taxonomy 418 as described with respect to FIGS. 1-14. As described above, the PDS 1608 similarly normalizes the business-entity job postings 1608e.

In a typical embodiment, via the normalizations described above, the deployment-processing module 1608f is operable to match human resources in the labor pool 1604 with ones of the business-entity job postings 1608e while considering, for example, the assignment logistics 1606d. The deployment-processing module 1608f is further typically operable to track and record information related to hires, or completed redeployments, from the plurality of human resources in the labor pool 1604 based on a job posting in the business-entity job postings 1608e. In a typical embodiment, the deployment processing module 1608f shares the recorded information related to hires with the applicant tracking system 1606 and the business-entity management 1608d. In that way, in a typical embodiment, the applicant tracking system may update the human-resource information for the labor pool 1504 and a fulfilled job posting may be removed from the business-entity job postings 1608e.

In a typical embodiment, the deployment-processing module 1608f enables the configuration of the labor pool 1604 described above with respect to the applicant tracking system 1606 to be a dynamic and continuous process. For example, transitions or redeployments into the private sector, in various embodiments, may be temporary or semi-permanent so that a return, for example, to the prior sector 1502 of FIG. 15 is planned or at least possible. In a typical embodiment, when the deployment processing module 1608f shares the recorded information related to hires with the applicant tracking system 1606, the applicant tracking system may utilize the correspond ones of the business-entity job postings as normalized by the PDS 1608 to update, for example, the skills/experience information 1606b. In that way, the applicant tracking system is operable to maintain a current snapshot of the plurality of human resources in the labor pool 1604. Thus, as a result, the plurality of human resources in the labor pool 1604 may be more effectively redeployed to the private sector and more effectively utilized, for example, in the public sector upon a return to the public sector.

The deployment business intelligence (BI) 1608g, in a typical embodiment, may include analytics related to various activities of the PDS 1608. In a typical embodiment, the PDS 1608 is operable to develop the deployment BI 1608g based on, for example, the information related to business-entity general-business profiling 1608a, business-entity skill-utilization profiling 1608b, business-entity technology/equipment profiling 1608c and business-entity management 1608d, the business-entity job postings 1608e and recorded hires. Other information may also be utilized. In that way, in a typical embodiment, the deployment BI 1608g may include analytics such as, for example, metrics identifying a degree to which business entities in the FTE employers 1610 utilize skills represented in the labor pool 1604. In various embodiments, the deployment BI 1608g may further include analytics such as, for example, metrics identifying a degree to which the business entities in the plurality of FTE employers 1610 hire from the labor pool 1604.

In various embodiments, the deployment BI 1608g may further drill down to more specific analytics such as, for example, from among the business entities in the plurality of FTE employers 1610 that utilize certain skills represented in the labor 1604 (e.g., a family or species in the HCM master taxonomy 418 of FIG. 4), a number of hires that were enacted by those business entities from the labor pool 1604 (e.g., at that family or species). In some embodiments, aggregate analytics may also be developed by the PDS 1608 as part of the deployment BI 1608g. For example, the aggregate analytics may include identifying, relative to the HCM master taxonomy 418, species at the job-species level 438 or families at the job-family level 428 that are in high demand by the plurality of FTE employers 1610.

FIG. 17 illustrates a system 1700 that may facilitate redeployment of human resources, for example, into the private sector. The system 1700 includes an applicant tracking system 1706, a PDS 1708, an outsource system 1718 and a plurality of outsource projects 1720. The system 1700 further includes a plurality of FTE employers 1710, a plurality of vendors 1714 of contingent or temporary labor and project work 1716. In a typical embodiment, the applicant tracking system 1706 and the PDS 1708 are similar to the applicant tracking system 1606 and the PDS 1608 of FIG. 16, respectively. Further, in a typical embodiment, the plurality of FTE employers 1710, the plurality of vendors 1714 of contingent or temporary labor and the project work 1716 are similar to the plurality of FTE employers 1610, the plurality of vendors 1614 of contingent or temporary labor and the project work 1616 of FIG. 16, respectively. Additionally, in a typical embodiment, the outsource system 1718 is similar to the outsource system 1518 of FIG. 15.

The plurality of outsource projects 1720 may be projects, for example, from multiple discrete entities within a prior workforce sector such as, for example, the prior workforce sector 1502 of FIG. 15. For example, in some embodiments, multiple units of government or other entities with aligned interests may pool projects together as part of the outsource projects 1720. In that way, the project work 1716 that is available to be awarded by the outsource system 1718 may be substantially increased in quantity. Additionally, in a typical embodiment, effectiveness of the PDS 1708 in placing human resources, for example, from the labor pool 1604 of FIG. 16 in the private sector may be increased due to increased leverage afforded by the outsource projects 1720.

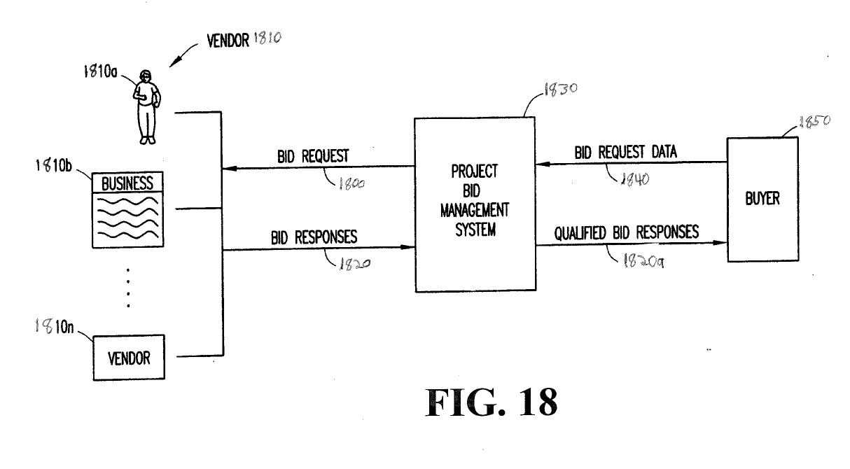

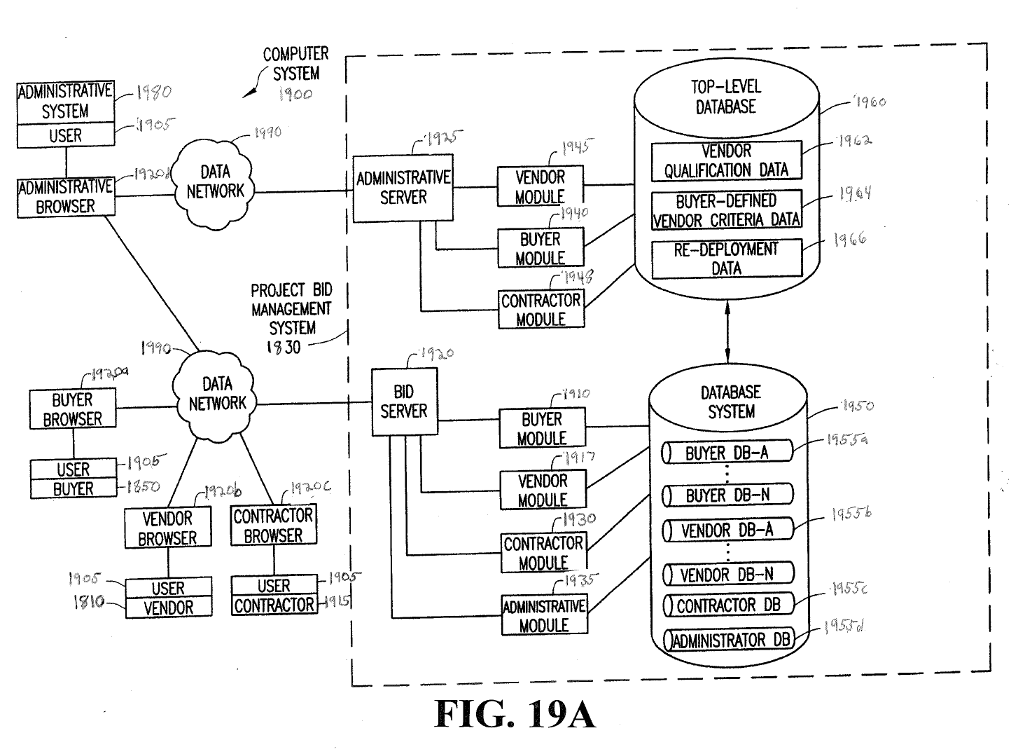

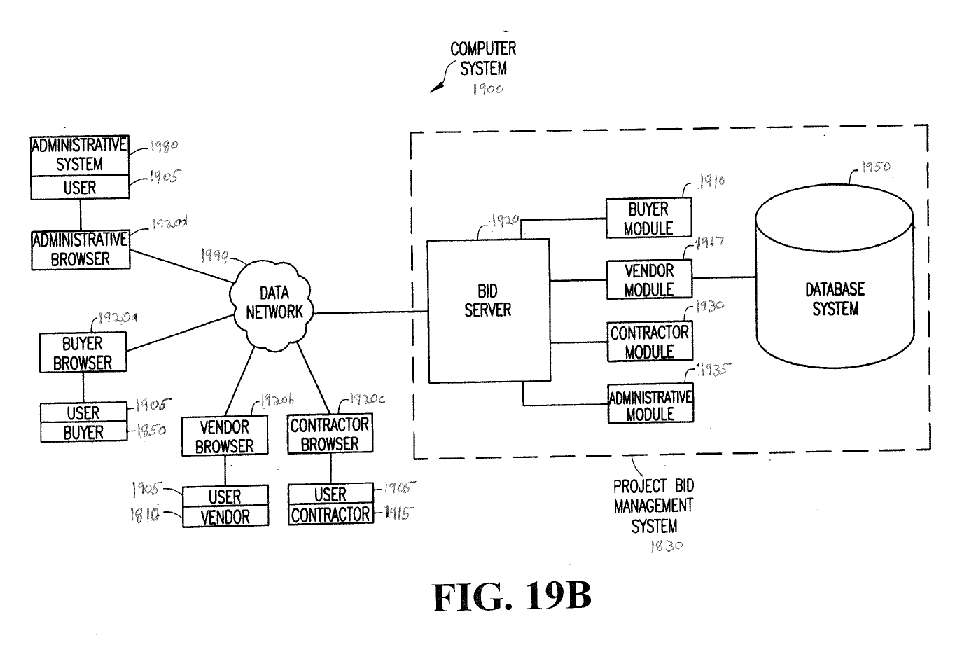

The outsource system 1718, in a typical embodiment, may include a bid-template and statement-of-work (SOW) module 1722, a PDS integrated-resource module 1724, a spend-management module 1726, a sub-contracting-management module 1728, a project-tracking module 1730 and a payment module 1732. The bid-template and SOW module 1722, in a typical embodiment, may include functionality, for example, to control a competitive bid process for purposes of outsourcing the project work 1716 to one or more of the plurality of FTE employers 1710. Further, for performing any project, the plurality of FTE employers 1710 may utilize contingent labor provided by the plurality of vendors/suppliers 1714. In a typical embodiment, the bid-template and SOW module 1722 may allow, for example, the outsource system 1718 to mandate utilization of, for example, ones of the plurality of human resources in the labor pool 1604 of FIG. 16. Examples of the bid-template and SOW module 1722 will be discussed in further detail with respect to FIGS. 18-19B.

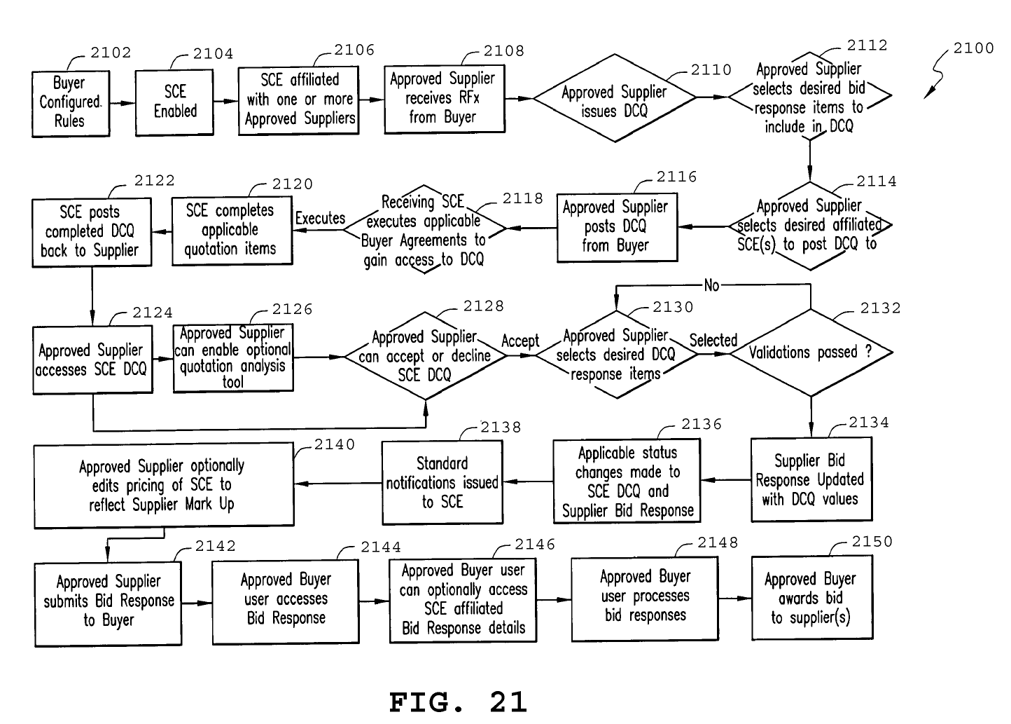

The sub-contracting-management module 1728, in a typical embodiment, is operable to extend functionality of the bid-template and SOW module 1722 to downstream contractors (i.e., subcontractors). For example, one of the plurality of FTE employers 1710 may be awarded the project work 1716 and subcontract portions of the project work 1716 to a subcontractor such as, for example, another one of the plurality of FTE employers 1710 or one of the plurality of vendors/suppliers 1714. One of ordinary skill in the art will recognize that multiple layers of subcontracting may occur. In a typical embodiment, the sub-contracting management module 1728 may allow, for example, the outsource system 1718 to mandate utilization of, for example, ones of the plurality of human resources in the labor pool 1604 of FIG. 16 for downstream contractors (i.e. subcontractors). Examples of the sub-contracting management module 1728 will be discussed in further detail with respect to FIG. 21.

The project-tracking module 1730, the spend-management module 1726 and the payment module 1732, in a typical embodiment, are operable to perform functionality for an awarded project such as, for example, one of the plurality of outsource projects 1720. The spend-management module 1726 generally manages and tracks all financial aspects for the awarded project through completion of project work defined by the awarded project. The payment module 1732 may manage, for example, payment for project work, for example, according to terms of a purchase requisition for the awarded project. The project-tracking module 1730 may track, for example, a completion status of project activities, generate project-performance metrics and manage project-activity scheduling. The project-tracking module 1730, in a typical embodiment, may confirm and enforce any required utilizations, for example, of the labor pool 1603 in staffing the project work 1716.

The PDS integrated-resource module 1724, in a typical embodiment, is operable to integrate resources of the PDS 1708 and the outsource system 1718 in a manner that optimizes both the PDS 1708 and the outsource system 1718. For example, in a typical embodiment, the PDS integrated-resource module is operable to inform the bid-template and SOW module 1722 and the sub-contracting-management module 1728 regarding the deployment BI 1608g of FIG. 16. In that way, business entities in the plurality of FTE employers 1710 that, for example, employ predetermined thresholds of the plurality of human resources in the labor pool 1604 may be awarded a greater portion of the project work 1716. The predetermined thresholds, in various embodiments may be expressed as a percentage of total employment of a business entity, as a total number of such hires, or as other metrics that will be apparent to one of ordinary skill in the art.

FIG. 18 illustrates a high-level functional view of a bid process that may be performed, for example, by the bid-template and SOW module 1722 of FIG. 17. Bid request data 1840 associated with a particular bid request 1800 is provided from a buyer 1850 to a project bid management system 1830. The buyer 1850, in a typical embodiment, may be an operator of the outsource system 1718 such as, for example, a unit of government. The bid request data 1840 received at the project bid management system 1830 is in a form pre-designated by the buyer 1850. For example, the form can include one or more bid items selected from a configurable pre-established list of bid items for the particular project type and the bid request data 1840 can be related to one or more of these selected bid items. In a typical embodiment, these selected bid items may include, for example, a bid item that quantifies a required utilization of the labor pool 1704 of FIG. 17 in staffing the project work 1716. The quantification may be expressed, for example, as a percentage of temporary staffing utilized for the project work 1716, as a percentage of money spent on temporary-staffing for the project work 1716 or as an overall number.

The bid request data 1840 is formatted by the project bid management system 1830 and transmitted as a bid request 1800 to one or more vendors 1810a . . . 1810n for solicitation of respective bid responses 1820. For example, the vendor 1810 can be business entities in the plurality of FTE employers 1710 of FIG. 17. Bid responses 1820 are submitted from the vendors 1810 to the project bid management system 1830 for review prior to forwarding qualified bid responses 1820a to the buyer 1850. For example, the project bid management system 1830 may be pre-configured to force vendor completion of required bid response items in a specific data format to enable the system 1830 to perform some filtering of vendor bid responses 1820. In this way, the system 1830 can ensure that the buyer 1850 only receives the bid responses 1820 that have the necessary data for bid evaluation.

In accordance with embodiments of the present invention, the project bid management system 1830 can be implemented within a computer system 1900, as is shown in FIG. 19A. A user 1905 enters the computer system 1900 through a data network 1990 via a web browser 1920. A user 1905 includes any person associated with a vendor 1810, buyer 1850, administrator 1980 (e.g., a third-party or buyer-employed administrator) or contractor 1915 assigned to a project. By way of example, but not limitation, the data network 1990 can be the Internet or an Intranet and the web browser 1920 can be any available web browser or any type of Internet Service Provider (ISP) connection that provides access to the data network 1990. Vendor users 1905 access the computer system through a vendor browser 1920b, buyer users 1905 access the computer system via a buyer browser 1920a, contractor users 1905 access the computer system via a contractor browser 1920c and administrative users 1905 access the computer system through an administrative browser 1920d. The users 1905 access the computer system 1900 through a web server 1920 or 1925 capable of pushing web pages to the vendor browser 1920a, buyer browser 1920b, contractor browser 1920c and administrative browser 1920d, respectively.

A bid web server 1920 enables vendors 1810, buyers 1850, contractors 1915 and administrators 1980 to interface to a database system 1950 maintaining data related to the vendors 1810, buyers 1850, contractors 1915 and administrators 1980. The data related to each of the vendors 1810, buyers 1850, contractors 1915 and administrators 1980 can be stored in a single database 1955, in multiple shared databases 1955 or in separate databases 1955 within the database server 1950 for security and convenience purposes, the latter being illustrated. For example, the database system 1950 can be distributed throughout one or more locations, depending on the location and preference of the buyers 1850, vendors 1810, administrators 1980 and contractors 1915.

The user interface to the vendor users 1905 is provided by the bid web server 1920 through a vendor module 1917. For example, the vendor module 1917 can populate web pages pushed to the vendor browser 1920b using the data stored in the particular vendor database 1955b. The user interface to the buyer users 1905 is provided by the bid web server 1920 through a buyer module 1910. For example, the buyer module 1910 can populate web pages pushed to the buyer browser 1920a using the data stored in the particular buyer database 1955a. The user interface to the contractor users 1905 is provided by the web server 1920 through a contractor module 1930. For example, the contractor module 1930 can populate web pages pushed to the contractor browser 1920c using the data stored in the contractor database 1955c. The user interface to the administrative users 1905 is provided by the bid web server 1920 through an administrative module 1935. For example, the administrative module 1935 can populate web pages pushed to the administrative browser 1920d using the data stored in the administrator database 1955d. It should be noted that the vendor module 1917, buyer module 1910, contractor module 1930 and administrative module 1935 can each include any hardware, software and/or firmware required to perform the functions of the vendor module 1917, buyer module 1910, contractor module 1930 and administrative module 1935, and can be implemented as part of the bid web server 1920, or within an additional server (not shown).

The computer system 1900 further provides an additional user interface to administrative users 1905 through an administrative web server 1925. The administrative web server 1925 enables administrators 1980 to interface to a top-level database 1960 maintaining data related to the vendors 1810, buyers 1850 and contractors 1915 registered with the computer system 1900. For example, the top-level database 1960 can maintain vendor qualification data 1962, buyer-defined vendor criteria data 1964 and contractor re-deployment data 1966.

To access information related to vendors 1810, the administrative web server 1925 uses a vendor module 1945 to push web pages to the administrative browser 1920d related to vendors 1810. For example, the vendor module 1945 can access vendor qualification information 1962 to qualify vendors 1810 for a particular buyer 1850 or for a particular industry. Likewise, the administrative web server 1925 can push web pages to the administrative browser 1920d related to the buyer-defined vendor criteria information 1964 through a buyer module 1940 in order to qualify vendors 1810 for a particular buyer 1850. The buyer-defined vendor criteria information 1964 may include information such as, for example, a predetermined threshold in hiring from the labor pool 1604 of FIG. 16. In various embodiments, the predetermined threshold may be expressed as a percentage of overall hires of the vendors 1810 that are from the labor pool 1604 or as an overall number of hires from the labor pool 1604.

A contractor module 1948 enables administrators 1980 to access contractor re-deployment data 1966 entered by contractors 1915 through the bid server 1920 and retrieved into the top-level database 1960 from a contractor database 1955. The re-deployment data 1966 can include, for example, an indication of the mobility of the contractor, desired geographical areas, contractor skills, desired pay and other contractor information that can be used to assist administrators 1980 in qualifying vendors 1810 for buyers 1850.

In another embodiment, as shown in FIG. 19B, the computer system 1900 can be implemented solely at the buyer network. In FIG. 19B, vendor users 1905 enter the computer system 1900 via a data network 1990 through a vendor browser 1920b, as in FIG. 19A. However, the web server 1920 in FIG. 19B is a buyer web server controlled and operated by a single buyer. The database system 1950 stores only the buyer data related to that particular buyer and only the vendor, contractor and administrator data pertinent to that particular buyer. For example, the vendor qualification data for only those vendors that are qualified by the buyer is stored in the database system 1950.

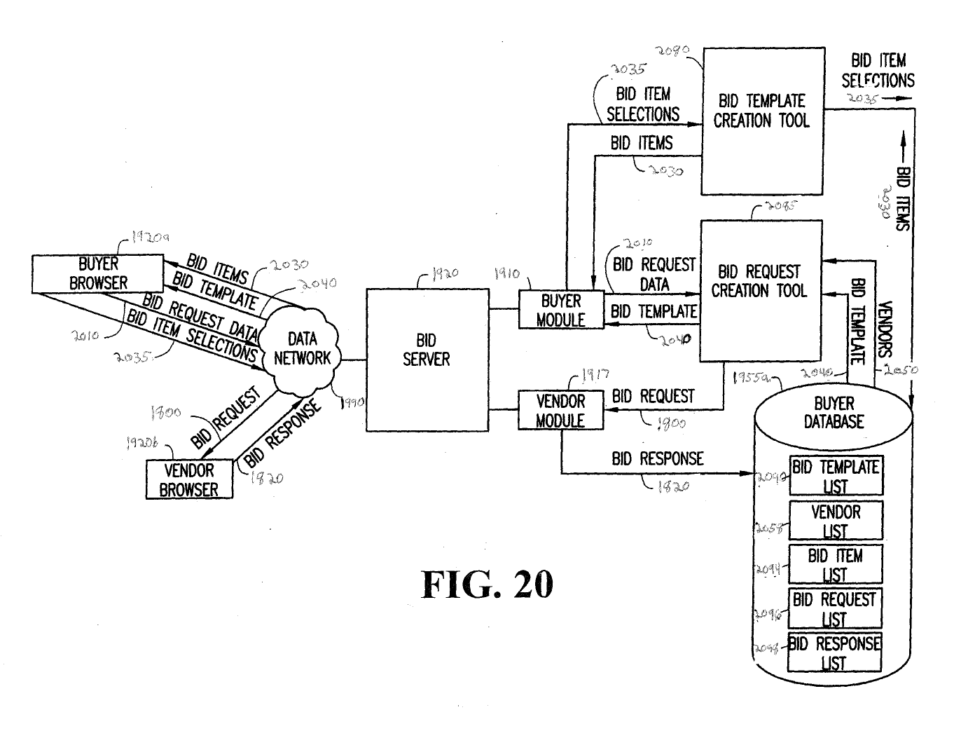

FIG. 20 illustrates exemplary functionality for creating a bid request utilizing a bid template that may be part of the bid-template and SOW module 1722 of FIG. 17. A bid template creation tool 2080 and bid request creation tool 2085 are illustrated in FIG. 20 for the creation of bid templates 2040 and bid requests 1800 from the bid templates 2040, respectively, in accordance with embodiments of the present invention. The bid template creation tool 2080 and bid request creation tool 2085 can include any hardware, software and/or firmware required to perform the functions of the tools, and can be implemented within the web server 1920 or an additional server (not shown). Each buyer can create one or more bid templates 2040, depending on the nature of project work outsourced by the buyer. For example, if the buyer has a need for staff supplementation in only one department, the buyer may create only one bid template 2040 to handle the staff supplementation bid requests 1800.

To create a bid template 2040, the bid template creation tool 2080 accesses the buyer database 1955a to retrieve bid items 2030 within a bid item list 2094 and provides the buyer with the bid item list 2030 via the buyer module 1910, web server 1920, data network 1990 and buyer browser 1920a for the buyer to choose from. The bid items 2030 are associated with specific types of information to be solicited from the buyer, vendor or both. From the list of bid items 2030, the buyer selects and provides one or more bid item selections 2035 for inclusion in a bid template 2040. Depending on buyer configurations, one or more of the bid items 2030 may be mandatory for the bid template 2040, such as the name of the buyer, location of the work to be performed, type of project work requested and a required utilization of a labor pool such as, for example, the labor pool 1704 of FIG. 17. For one or more of the mandatory bid items 2030, in addition to including the mandatory bid items 2030 in the bid template 2040, the specific information associated with each of the mandatory bid items 2030 can also be included in fields associated with the mandatory bid items 2030 within the bid template 2040. For example, the buyer name, project work type and required utilization of the labor pool can be stored in the bid template 2040 for that project work type. Each bid template 2040 created by the buyer is stored in the buyer database 1955a within a bid template list 2090 for later use in creating a bid request 1800.

To create a bid request 1800, the bid request creation tool 2085 accesses the buyer database 1955a to retrieve the bid templates 2040 stored within the bid template list 2090 and provides a list of bid templates 2040 to the buyer via the buyer module 1910, web server 1920, data network 1990 and buyer browser 1920a for the buyer to choose from. Upon selecting an appropriate bid template 2040, the buyer provides bid request data 2010 to the bid request creation tool 2085 for inclusion in a bid request 1800 of the bid template 2040 type. For example, the buyer can enter bid request data 2010 into provided fields for each bid item selection 2035 that requires information from the buyer within the bid template 2040. By way of example, but not limitation, the bid request data 2010 could include the location of work to be performed, the timing of the project and the specific vendor qualifications necessary for the project.

The bid request creation tool 2085 further interfaces with the buyer database 1955a to access a vendor list 2058 for the buyer and determine the appropriate vendors to receive the bid request. The appropriate vendors can be selected based on the bid template 2040 type and any other vendor qualifications included within the bid request 1800 itself. Thus, the vendor list 2058 can be separated into pre-qualified vendors for bid template 2040 types to further reduce processing time when submitting bid requests 1800. For example, the vendor qualifications may include a predetermined threshold in hiring from the labor pool 1604 of FIG. 16. In various embodiments, the predetermined threshold may be expressed as a percentage of overall hires of the vendors 1810 that are from the labor pool 1604 or as an overall number of hires from the labor pool 1604. The bid request creation tool 2085 further uses vendor contact information 2050 associated with the selected vendors to broadcast (transmit) the bid request 1800 to the appropriate vendors (as shown in FIGS. 18-19B) via the vendor module 1917, web server 1920, data network 1990 and vendor browser 1920b, and stores the submitted bid request 1800 in a bid request list 2096 for the buyer.

Vendor bid responses 1820 received from solicited vendors (as shown in FIGS. 18-19B) can further be stored in the buyer database 1955a in a bid response list 2098 for later use, for example, in comparing and grading vendor bid responses 1820. The vendor bid responses 1820 are generated from the bid items included in the bid request 1800. Specifically, the vendor populates data associated with the vendor and the bid response in data fields within enabled bid items in the bid request 1800. Vendors access the bid request 1800 via the vendor module 1917 to view the bid request and complete the vendor response and submit completed bid responses 1820 via the vendor module 1917 for storage in the buyer database 1955a via the buyer module 1910 (step not shown). The bid response 1820 can include data retrieved from a vendor database 1955b (not shown) and can be stored in the vendor database 1955b during and after the bid response creation.

FIG. 21 illustrate exemplary subcontracting-entity (SCE) enablement and management. In FIG. 21, a flow 2100 is shown that may be performed by the sub-contracting-management module 1728 of FIG. 17. The flow 2100 includes steps 2102-2150. Steps 2102-2106 relate to SCE enablement. Steps 2108-2142 relate to daisy-chain bid-response processing. Steps 2144-2150 relate to buyer bid response processing.

The flow 2100 begins at step 2102, at which step rules are configured by the buyer relative to an SCE. At step 2104, the SCE is enabled and program-configured supplier-load requirements are set. At step 2106, the SCE is affiliated with one or more approved suppliers. At step 2108, an approved supplier receives a request for quote/request for proposal/request for bid (RFx) from the buyer. At step 2110, the approved supplier decides to issue a daisy-chain quotation. The term daisy chain is used in the context of handling and transmission of work flow elements between entities in which one or more records are parsed from a master record. The parsed records are then transmitted from one entity to another, such that a receiving entity has access to the parsed and transmitted records. Upon further processing, the parsed transmitted records may be reintegrated back into the master record for further handling as part of the work flow. A daisy-chain quotation and a daisy-chain acquisition are examples of how a daisy-chain concept may be used in the context of the work flow process described herein. In response to the decision, at step 2110, to issue a daisy-chain quotation, at step 2112, the approved supplier selects desired bid response items to include in the daisy-chain quotation. The items included in the daisy-chain quotation must include at least one selection of a billable services/goods item. The items included in the daisy-chain quotation may specify, for example, a required utilization of the labor pool 1704 of FIG. 17 in staffing the project work 1716. The quantification may be expressed, for example, as a percentage of temporary staffing utilized for the project work 1716, as a percentage of money spent on temporary-staffing for the project work 1716 or as an overall number.

From step 2112, execution proceeds to step 2114. At step 2114, the approved supplier selects desired affiliated SCEs to which to post the daisy-chain quotation. At step 2116, the approved supplier posts the daisy-chain quotation and standard solution notifications are initiated. Standard solution notifications include, for example, so-called on-line dashboard notifications as well as e-mail notifications. From step 2116, execution proceeds to step 2118. At step 2118, a receiving SCE executes applicable buyer agreements to gain access to the daisy-chain quotation. Upon execution of the applicable buyer agreements at step 2118, execution proceeds to step 2120. At step 2120, the SCE completes applicable quotation items. At step 2122, the SCE posts the completed daisy-chain quotation back to the supplier.

At step 2124, the approved supplier accesses the SCE daisy-chain quotation. From step 2124, execution may proceed to either step 2126 or 2128. If, as step 2124, the approved supplier determines that an optional quotation analysis tool is to be used, execution proceeds to step 2126. If, however, the approved supplier does not want to use the quotation analysis tool, execution proceeds to directly to step 2128. At step 2126, the approved supplier may enable the optional quotation analysis tools. The quotation analysis tools permit daisy-chain quotation grading and scoring to occur. At step 2128, the approved supplier may accept or decline the SCE daisy-chain quotation. If the approved supplier accepts the SCE daisy-chain quotation, execution proceeds to step 2130.

At step 2130, the approved supplier selects daisy-chain quotation response items. For example, the approved supplier may select all or less than all of the daisy-chain quotation response items received from an SCE when certain response items are acceptable to the approved supplier and others are not. The selected response items must include at least one voucherable services/goods item. In response to selection of the desired daisy-chain quotation response items, execution proceeds to step 2132. At step 2132, a determination is made as to whether all necessary validations have been passed. For example, a validation could fail if the approved supplier were to attempt to select multiple bid response items for the same bid item. If it is not determined that all necessary validations have been passed, execution returns to step 2130. If, however, it is determined that all necessary validations have passed, execution proceeds from step 2132 to step 2134.

At step 2134, a supplier bid response is updated with the daisy-chain quotation values validated at step 2132. At step 2136, applicable status changes to the SCE daisy-chain quotation and supplier bid response are made. For example, once the selected daisy-chain quotation response items have been accepted by the supplier, the status of those items may be changed from pending to accepted. At step 2138, standard notifications are issued to the SCE. At step 2140, the approved supplier may optionally edit pricing of the SCE to reflect applicable supplier mark-ups. In various embodiments of the invention, the editing of SCE pricing by the approved supplier must not reduce the SCE pricing and must comply with configured allowable mark-up percentages as set by the buyer. From step 2140, execution proceeds to step 2142. At step 2142, the approved supplier submits the bid response to the buyer.

At step 2144, the buyer accesses the bid response. At step 2146, the approved buyer may optionally access via a user interface all SCE affiliated bid response details. At step 2148, the buyer processes the bid responses. At step 2150, the buyer awards the bid.

One of ordinary skill in the art will appreciate that the applicant tracking system 1506 of FIG. 15, the applicant tracking system 1606 of FIG. 16, and the applicant tracking system 1706 of FIG. 17 may be implemented on one or more server computers having a processor and memory over a computer network. Further, one of ordinary skill in the art will appreciate that the PDS 1508 of FIG. 15, the PDS 1608 of FIG. 16, and the PDS 1708 of FIG. 17 may be implemented on one or more server computers having a processor and memory over a computer network. Likewise, one of ordinary skill in the art will appreciate that the outsource system 1518 of FIG. 15 and the outsource system 1718 of FIG. 17 may be implemented on one or more server computers having a processor and memory over a computer network For example, the one or more server computers mentioned above may be similar to the bid server 1920 of FIG. 19A.

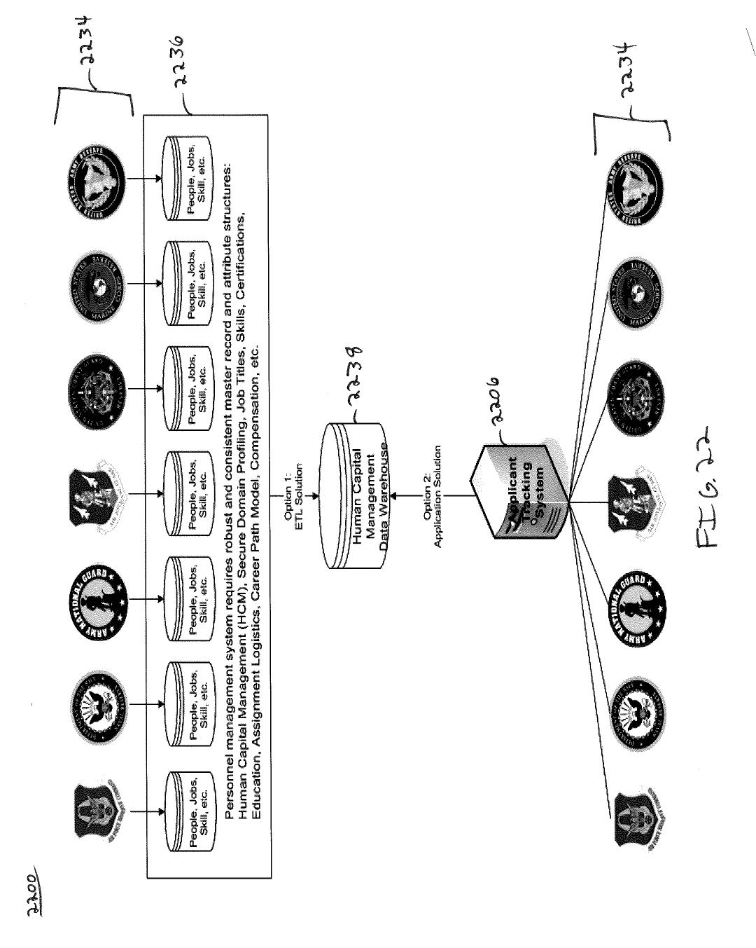

FIG. 22 illustrates a system 2200 with particular focus on an exemplary applicant tracking system. In a typical embodiment, the system 2200 includes a plurality of public-sector entities 2234, a plurality of human-resource-information data stores 2236, a HCM data warehouse 2238 and an applicant tracking system 2206. In a typical embodiment, the applicant tracking system 2206 is similar to the applicant tracking system 1506 of FIG. 15, the applicant tracking system 1606 of FIG. 16 and the applicant tracking system 1706 of FIG. 17.

In various embodiments, the plurality of public-sector entities 2234 may each store separate representations of skills and experience for human resources such as, for example, the plurality of human resources in the labor pool 1704 of FIG. 17. The separate representations typically may be stored in the plurality of human-resource-information data stores 2236. As mentioned with respect to FIG. 17, it is beneficial in various embodiments to leverage project work from multiple entities such as, for example, multiple public-sector entities in the public sector. In various embodiments, it may also be beneficial to centrally store data from the plurality of human-resource-information data stores 2236 in the HCM data warehouse 2238 in a uniform structured format.

In a typical embodiment, the HCM data warehouse 2238 may be developed, for example, by extracting data from the plurality of data stores 2236, transforming the data into a normalized format such as, for example, via the HCM master taxonomy 418 as described with respect to FIGS. 1-14 and loading the transformed data into the HCM data warehouse 2238. In a typical embodiment, the HCM data warehouse 2238 may also be developed and/or updated via individuals with the plurality of public-sector entities 2234 directly providing information to the applicant tracking system 2206. The applicant tracking system may then store the provided information to the HCM data warehouse 2238.

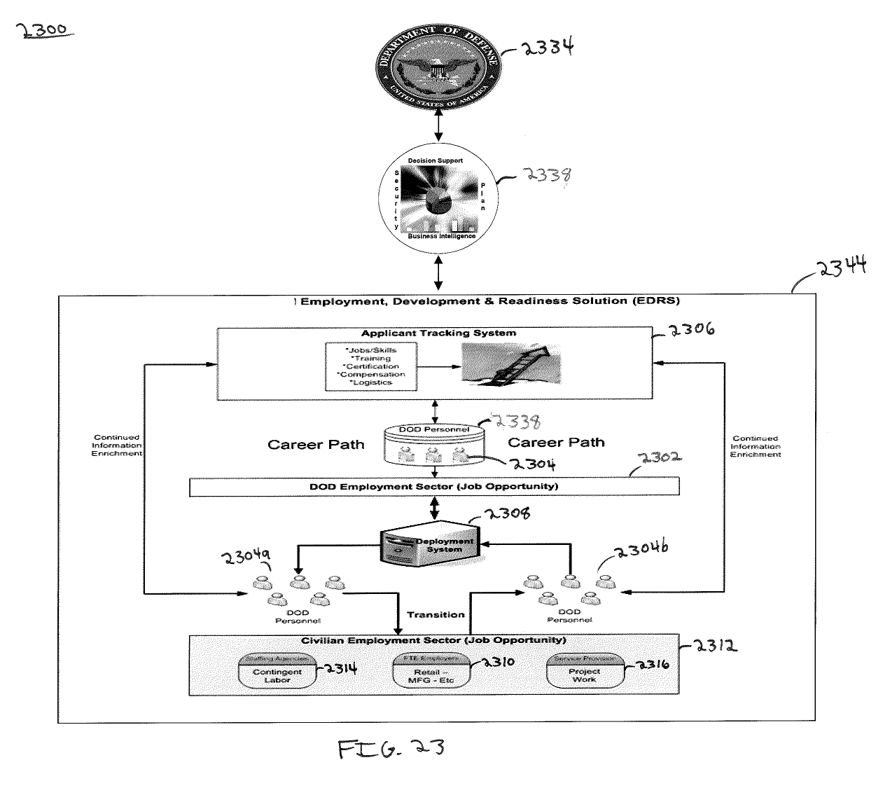

FIG. 23 illustrates a system 2300 that may facilitate repeated workforce transitions (i.e., redeployments) between two workforce sectors. The system 2300 typically includes a public-sector entity 2334 from the public sector, a decision-support system 2338 and an employment, development and readiness solution (EDRS) 2344. The EDRS 2344 typically includes an applicant tracking system 2306, a HCM data warehouse 2338, a first workforce sector 2302, a PDS 2308 and a project-work sphere 2312. In a typical embodiment, the HCM data warehouse 2338 stores a structured representation of a labor pool 2304. The project-work sphere 2312 generally includes a plurality of FTE employers 2310, a plurality of vendors 2314 of contingent or temporary labor and project work 2316.

In a typical embodiment, the applicant tracking system 2306 may be similar to the applicant tracking systems 1506, 1606, 1706 and 2206 of FIGS. 15, 16, 17 and 22, respectively. In a typical embodiment, the first work force sector 2302 may be similar to the prior workforce sector 1502 of FIG. 15. In a typical embodiment, the labor pool 2304 may be similar to the labor pools 1504 and 1604 of FIGS. 15 and 16, respectively. In a typical embodiment, the HCM data warehouse 2338 may be similar to the HCM data warehouse 2238 of FIG. 22. In a typical embodiment, the PDS 2308 may be similar to the PDSs 1508, 1608 and 1708 of FIGS. 15, 16 and 17, respectively. In a typical embodiment, the project-work sphere 2312 may be similar to the project-work spheres 1512 and 1612 of FIGS. 15 and 16, respectively.

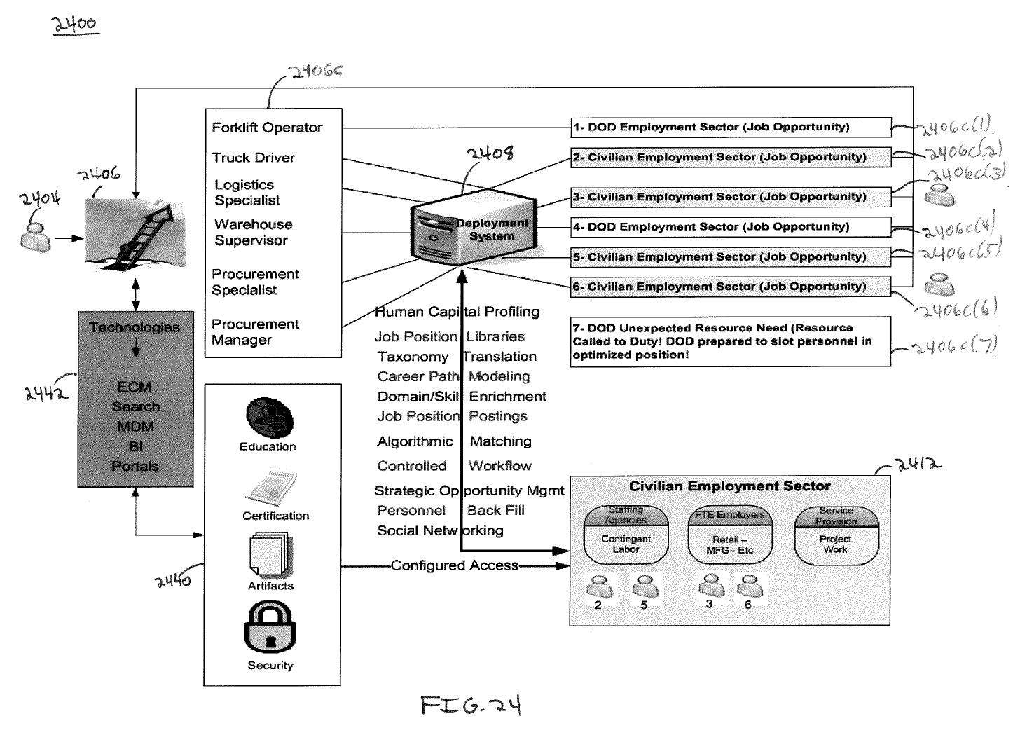

In a typical embodiment, the applicant tracking system 2306 may interact with the HCM data warehouse 2338 as described with respect to the applicant tracking system 2206 and the HCM data warehouse 2238 of FIG. 22. In a typical embodiment and as illustrated in FIG. 23, the PDS 2308 may facilitate deployment of human resources in the labor pool 2304 both from the first workforce sector 2302 (e.g., the public sector) to the private sector (e.g., entities in the project-work sphere 2312) and from the private sector back to the first workforce sector 2302 via the PDS 2308. As depicted in FIG. 23, human resources 2304a represent human resources from the labor pool 2304 being redeployed from the first workforce sector 2302 to the private sector via the PDS 2308. Similarly, as depicted in FIG. 23, human resources 2304b represent human resources from the labor pool 2304 being redeployed from the private sector back to the first workforce sector 2302. One of ordinary skill in the art will appreciate that a particular human resource may undergo many redeployments, for example, between the first workforce sector and the private sector. In a typical embodiment, the HCM data warehouse 2338 includes information that tracks a career path taken by human resources in the labor pool 2304 across the first workforce sector 2302 and the private sector. Career-path tracking will be described in further detail with respect to FIG. 24.

The decision-support system 2338, in a typical embodiment, may be utilized by the public-sector entity 2334, for example, to develop business intelligence and analytics based on information provided by the EDRS. For example, the decision-support system 2338 may utilize information, for example, from the HCM data warehouse 2338 or the PDS 2308 to project human-resource availability for particular skill sets, develop budgets or develop other analytics. One of ordinary skill in the art will recognize that the decision-support system 2338 may be utilized in many ways to enhance decision-making activities and other activities of the public-sector entity 2334.

FIG. 24 illustrates a system 2400 that may be operable to track and model a human-resource career path that crosses workforce sectors. In a typical embodiment, the system 2400 includes a human resource 2404, an applicant tracking system 2406, a plurality of data-leveraging technologies 2442, a career-development plan 2406c, a series of exemplary career-path steps 2406c(1)-(7) and a project-work sphere 2412. The applicant tracking system 2406, in a typical embodiment, may be similar to the applicant tracking systems 1506, 1606, 1706, 2206 and 2306 of FIGS. 15, 16, 17, 22 and 23, respectively.

In a typical embodiment, the applicant tracking system 2406 may obtain and store the career-development plan 2406c in a manner similar to that described with respect to the career-development plans 1606c of FIG. 16. In various embodiments, the applicant tracking system 2406 may further store and maintain human-capital information 2440 for the human resource 2404 that may include, for example, education attainted, certifications attained, any security clearance and artifacts evidencing, for example, the education or certifications attained or the security clearance. In various embodiments, the applicant tracking system may further utilize the plurality of data-leveraging technologies 2442 to make the human-capital information 2440 more useful and actionable. The plurality of data-leveraging technologies 2442 may include, for example, enterprise-content-management (ECM) technologies, search technologies, master-data-management technologies (MDM), BI-development technologies and portal technologies. In various embodiments, the applicant tracking system 2406 may allow business entities within the project-work sphere 2412 to have secure access to the human-resource information 2440 and utilize the plurality of data-leveraging technologies 2442.

In a typical embodiment, the career-development plan 2406c may specify a series of steps, or a career path, for the human resource 2404 to take in order to progressively advance towards one or more career goals. In various embodiments, the one or more career goals may be personal goals of the human resource 2404. In some embodiments, the one or more career goals may also factor in the needs, for example, of a public-sector entity in the public sector. Solely as an example, the career-development plan 2406c is depicted in FIG. 24 as including an exemplary series of employment positions that the human resource 2404 may occupy in furtherance of the career-development plan 2406c. The exemplary series of employment positions includes: a forklift-operator position, a truck-driver position, a logistics-specialist position, a warehouse-supervisor position, a procurement-specialist position and a procurement-manager position.

The series of exemplary career-path steps 2406c(1)-(7) of FIG. 24 illustrates in an exemplary manner how, in a typical embodiment, the PDS 2408 may utilize the career-development plan 2406c in redeploying the human resource 2404. At a step 2406c(1), the human resource 2404 may be deployed to a job opportunity in the public sector as a forklift operator. Following a period of time working as a forklift operator in the public sector, at a step 2406c(2), the human resource 2404 may be redeployed to a job opportunity in the private sector as a truck driver. Following a period of time working as a truck driver in the private sector, at a step 2406c(3), the human resource 2404 may be redeployed to another job opportunity in the private sector as a logistics specialist. Following a period of time working as a logistics specialist in the private sector, at a step 2406c(4), the human resource 2404 may be redeployed to a job opportunity in the public sector as a warehouse supervisor.

Still describing the series of exemplary career-path steps 2406c(1)-(7), following a period of time working as a warehouse supervisor in the public sector, at a step 2406c(5), the human resource 2404 may be redeployed to a job opportunity in the private sector as a procurement specialist. Following a period of time working as a procurement specialist in the private sector, at a step 2406c(6), the human resource 2404 may be redeployed to another job opportunity in the private sector as a procurement manager. At a step 2406c(7), the human resource may be recalled to the public sector based on unexpected needs in the public sector. At the step 2406c(7), the PDS 2408 may match one of the unexpected needs in the public sector using the career-path and the career-path plan 2406c of the human resource 2404. One of ordinary skill in the art will recognize that, although specific steps and employment positions are described above, the steps, a sequence of the steps and the employment positions are solely exemplary in nature.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method comprising:
configuring a labor pool, the labor pool comprising a plurality of human resources in a first workforce sector;
wherein said configuring a labor pool comprises storing human-resource information;
configuring a plurality of business entities operating in a second workforce sector that is distinct from the first workforce sector;
wherein said configuring a plurality of business entities comprises storing job-opening information for a plurality of job openings;
normalizing the labor pool to a human-capital management (HCM) taxonomy via at least a portion of the human-resource information;
normalizing the plurality of job openings to the HCM taxonomy via at least a portion of the job-opening information;
facilitating a redeployment of at least one human resource in the normalized labor pool from the first workforce sector to the second workforce sector, the facilitating comprising matching the at least one human resource to at least one job opening in the normalized plurality of job openings; and
wherein the method is performed via one or more computers having a processor and memory.

2. The method of claim 1, wherein the human-resource information is selected from the group consisting of: personal-profiling information, one or more skills, experience, a career-development plan and assignment logistics.

3. The method of claim 1, wherein said configuring a plurality of business entities comprises:
business-entity general-business profiling;
business-entity skill-utilization profiling; and
business-entity technology profiling.

4. The method of claim 3, the method comprising prompting a business entity in the plurality of business entities to update information related to the business-entity general-business profiling.

5. The method of claim 1, the method comprising:
wherein the HCM taxonomy comprises a plurality of levels that range from more general to more specific, each level of the plurality of levels comprising a plurality of nodes;
wherein the plurality of levels comprises a job-species level and a job-family level, the job-species level comprising a level of greatest specificity in the plurality of levels, the job-family level comprising a level of specificity immediately above the job-species level;

6. The method of claim 5, wherein said normalizing the labor pool comprises:
transforming the human-resource information via a HCM language library; and
classifying the transformed human-resource information into a job-family node selected from the plurality of nodes at the job-family level.

7. The method of claim 6, wherein said normalizing the plurality of job openings comprises:
transforming the job-opening information via the HCM language library; and
classifying the transformed job-opening information into a job-family node selected from the plurality of nodes at the job-family level.

8. The method of claim 7, wherein said matching the at least one human resource to at least one job opening comprises determining the at least one human resource and the at least one job opening to be classified at a same job-family node at the job-family level.

9. The method of claim 8, the method comprising:
recording a hire of the at least one human resource based on the at least one job opening; and
updating the human-resource information based on the recorded hire.

10. The method of claim 9, the method comprising:
wherein said matching the at least one human resource to at least one job opening comprises matching more than one of the plurality of human resources to selected ones of the plurality of job openings;
wherein said recording a hire comprises recording a plurality of hires based on the selected ones of the plurality of job openings.

11. The method of claim 10, the method comprising:
developing business intelligence via the plurality of recorded hires;
wherein the developing comprises analyzing a degree to which the plurality of business entities hire from the labor pool.

12. The method of claim 11, wherein the developing comprises analyzing the recorded plurality of hires by placement in the HCM taxonomy.

13. The method of claim 12, wherein the developing comprises comparing the recorded plurality of hires by job family at the job-family level.

14. The method of claim 7, wherein the method comprises at least one of:
classifying the transformed human-resource information into a selected job-species node from the plurality of job-species nodes; and
configuring a new job-species node for the human-resource information beneath the job-family node.

15. The method of claim 14, wherein the method comprises at least one of:
classifying the transformed job-opening information into a selected job-species node from the plurality of job-species nodes; and
configuring a new job-species node for the job-opening information beneath the job-family node.

16. The method of claim 15, wherein said matching the at least one human resource to at least one job opening comprises determining the at least one human resource and the at least one job opening to be classified at a same job-species node at the job-species level.

17. The method of claim 1, wherein:
the first workforce sector comprises a buyer in a project work sphere, the project work sphere comprising the plurality of business entities; and
transmitting a bid request for project work to selected ones of the plurality of business entities.

18. The method of claim 17, wherein the bid request comprises a plurality of bid items, at least one of the plurality of bid items quantifying a required utilization of the labor pool in staffing the project work.

19. The method of claim 18, wherein:
the bid request is only transmitted to qualified ones of the plurality of business entities, the qualified ones of the plurality of business entities comprising business entities that have reached at least a predetermined threshold in hiring from the labor pool.

20. The method of claim 17, the method comprising:
transmitting a daisy-chain bid request to an enabled subcontracting entity; and
wherein the daisy-chain bid request comprises a plurality of parsed bid items from the bid request, at least one of the plurality of parsed bid items quantifying a required utilization of the labor pool in staffing the project work.

21. The method of claim 17, the method comprising wherein the project work comprises project work from a plurality of projects from a plurality of entities within the first workforce sector.

22. The method of claim 1, wherein the labor pool comprises human resources from a plurality of entities in the first workforce sector.

23. The method of claim 1, the method comprising:
wherein the human-resource information comprises a career-development plan; and
wherein said facilitating of a redeployment from the first workforce sector to the second workforce sector is based on the career-development plan.

24. The method of claim 24, the method comprising:
facilitating a redeployment of the at least one human resource from the second workforce sector to the first workforce sector; and
wherein said facilitating of a redeployment from the first workforce sector to the second workforce sector is based on the career-development plan.

25. A computer-program product comprising a computer-usable medium having computer-readable program code embodied therein, the computer-readable program code adapted to be executed to implement a method comprising:
configuring a labor pool, the labor pool comprising a plurality of human resources in a first workforce sector;
wherein said configuring a labor pool comprises storing human-resource information;
configuring a plurality of business entities operating in a second workforce sector that is distinct from the first workforce sector;
wherein said configuring a plurality of business entities comprises storing job-opening information for a plurality of job openings;
normalizing the labor pool to a human-capital management (HCM) taxonomy via at least a portion of the human-resource information;
normalizing the plurality of job openings to the HCM taxonomy via at least a portion of the job-opening information; and
facilitating a redeployment of at least one human resource in the normalized labor pool from the first workforce sector to the second workforce sector, the facilitating comprising matching the at least one human resource to at least one job opening in the normalized plurality of job openings.
